(19) United States
(12) Patent Application Publication
(10) Pub. No.: US 2008/0219445 A1
(43) Pub. Date: Sep. 11, 2008

(54) Communications audit support system

(76) Inventors: Akifumi Yato, Kawasaki (JP); Tadashi Kaji, Yokohama (JP); Takahiro Fujishiro, Yokohama (JP); Yoko Hashimoto, Yokohama (JP); Kazuyoshi Hoshino, Tokyo (JP)

Correspondence Address: MCDERMOTT WILL & EMERY LLP, 600 13TH STREET, N.W., WASHINGTON, DC, 20005-3096, US

(21) Appl. No.: 11/984,676

(22) Filed: Nov. 20, 2007

(30) Foreign Application Priority Data
Mar. 5, 2007 (JP) 2007-053708

(51) Int. Cl. H04L 9/00; H04K 1/00

(52) U.S. Cl. 380/255; 380/277

(57) ABSTRACT

A communications audit support system is provided, which makes it possible to audit communications of an arbitrary encrypted communication session at any time. The communications audit support system of the present invention stores key information used for encrypted communication in a key management DB in association with a key ID each time the key information is created, stores IP addresses of a user terminal and a service providing server which perform an encrypted communication session using the key information in a communication state management DB in association with the key ID, and stores an encrypted packet sent in an encrypted communication session in a packet DB in association with IP addresses of a sender and a receiver of the encrypted packet.

### INCORPORATION BY REFERENCE

This application claims priority based on a Japanese patent application, No. 2007-53708 filed on Mar. 5, 2007, the entire contents of which are incorporated herein by reference.

### BACKGROUND OF THE INVENTION

The present invention relates to a technique for decrypting encrypted communications and auditing the same.

For the purpose of investigating an incident or the like, an external auditing organization or the like may audit communications by collecting communication data that is sent over a network and analyzing the collected communication data. When the communications are encrypted, the auditing organization can collect encrypted communication data but cannot understand the communications.

This can be avoided by a technology called key escrow. In the key escrow, a user who initiates an encrypted communication session leaves a key that is used in the encrypted communication session with a third-party organization and, when the need arises for an auditing organization to audit communications, the auditing organization obtains the key that is used in the encrypted communication session to be audited, from the third-party organization, and then audits communications exchanged in the encrypted communication session (see, for example, U.S. Pat. No. 5,535,276).

### SUMMARY OF THE INVENTION

The technique disclosed in the above publication allows an auditing organization to obtain a key associated with a user from a third-party organization and to audit communications of the user when the need arises for the communications to be audited by some auditing organization, enabling the auditing organization to audit the communications that are exchanged after the key is obtained but not enabling auditing of the communications prior to the acquisition of the key.

A possible solution is to collect and store communications in every encrypted communication session irrespective of whether the communication session is to be audited or not. However, in many cases, a key used for encrypted communication loses its encrypting ability with the passage of the time after its generation, and accordingly the key is updated at given timing. This results in a situation where an auditing organization obtains a key that is effective at the time the need arises for communications to be audited by some auditing organization but cannot audit communications of a past encrypted communication session that took place with a key different from the obtained key.

The present invention has been made in view of the above circumstances, and the present invention provides a communications audit support system that enables an auditing organization to audit communications of an arbitrary encrypted communication session at any point in time, as well as a device or a method that makes the system possible.

A communications audit support system of the present invention is configured to: store key information, which is used in an encrypted communication session, in association with a key ID each time the key information is created; store, in association with the key ID, the IP address of a communication device that performs the encrypted communication session in which the key information is used; and store an encrypted packet that is sent in the encrypted communication session in association with the IP addresses of a sender and a receiver of the encrypted packet.

For example, according to a first aspect of the present invention, there is provided a communications audit support system which provides information necessary to audit encrypted communication performed between multiple communication devices, including: a key management unit which, each time key information used for encrypted communication is created, stores the created key information in a key management database (DB) in association with a key ID with which the key information is identified; a communication management unit which, each time an encrypted communication session is established, stores IP addresses of multiple communication devices that hold the encrypted communication session in a communication state management DB in association with a key ID of key information used in the encrypted communication session; a packet acquisition unit which obtains a copy of an encrypted packet sent in encrypted communication, and stores the obtained copy of the encrypted packet in a packet DB in association with IP addresses of a sender and a receiver of the encrypted packet; and a communication information output unit which refers to the communication state management DB upon reception of a search instruction from a user, identifies a key ID associated with an IP address of a communication device that has performed an encrypted communication session identified by the search instruction, extracts, from the key management DB, key information that is associated with the identified key ID, extracts, from the packet DB, a copy of an encrypted packet that is identified by the search instruction, and outputs the extracted key information and copy of the encrypted packet.

For example, according to a second aspect of the present invention, there is provided a communications audit support system which provides information necessary to audit encrypted communication performed between multiple communication devices, including: a key management unit which, each time key information used for encrypted communication is created, stores the created key information in a key management database (DB) in association with a key ID with which the key information is identified; a communication management unit which: stores, when an encrypted communication session is established, characteristic information unique to each of multiple communication devices that perform the encrypted communication session, IP addresses of the multiple communication devices, and a time at which the encrypted communication session is started, in a communication state management DB in association with a key ID of key information used in the encrypted communication session; and stores, after the encrypted communication session is ended, a time at which the encrypted communication session using the key information is ended in the communication state management DB in association with the key ID of the key information; a packet acquisition unit which obtains a copy of an encrypted packet sent in encrypted communication, and stores the obtained copy of the encrypted packet in a packet DB in association with IP addresses of a sender and a receiver of the encrypted packet, and with a time at which the copy of the encrypted packet is obtained; and a communication information output unit which: refers to the communication state management DB upon reception of a search instruction from a user; identifies a key ID associated with characteristic information and IP address of a communication device that has performed an encrypted communication session identified by the search instruction, and with a start time and an end time of the encrypted communication session; extracts, from the key management DB, key information that is associated with the identified key ID; extracts, from the packet DB, a copy of an encrypted packet that is identified by the search instruction; and outputs the extracted key information and copy of the encrypted packet.

According to a communications audit support system of the present invention, communications of an arbitrary encrypted communication session can be audited at any time.

These and other benefits are described throughout the present specification. A further understanding of the nature and advantages of the invention may be realized by reference to the remaining portions of the specification and the attached drawings.

### BRIEF DESCRIPTION OF THE DRAWINGS

In the accompanying drawings:

FIG. 1 is an exemplary diagram showing function configurations of devices that constitute a communications audit support system according to a first embodiment of the present invention;

FIG. 2 is an exemplary diagram showing a configuration of a computer that implements functions of a session management device, a key management device, a user terminal, a service providing server, a packet monitoring device, or an auditing device;

FIG. 3 is a sequence exemplary diagram (1) showing how the communications audit support system of the first embodiment operates in encrypted communication start-up/key update processing;

FIG. 4 is a sequence exemplary diagram (2) showing how the communications audit support system of the first embodiment operates in the encrypted communication start-up/key update processing;

FIG. 5 is a sequence exemplary diagram (3) showing how the communications audit support system of the first embodiment operates in the encrypted communication start-up/key update processing;

FIG. 6 is a sequence exemplary diagram showing how the communications audit support system of the first embodiment operates at the end of an encrypted communication session;

FIG. 7 is a sequence exemplary diagram showing how the communications audit support system of the first embodiment operates in encrypted packet monitoring;

FIG. 8 is a sequence exemplary diagram (1) showing encrypted communication audit processing in the communications audit support system of the first embodiment;

FIG. 9 is a sequence exemplary diagram (2) showing the encrypted communication audit processing in the communications audit support system of the first embodiment;

FIGS. 10A to 10D are exemplary diagrams showing data configuration of a communication start request, a communication start response, a communication end request, and a communication end response, respectively;

FIGS. 11A to 11D are each exemplary diagrams showing configuration of data that is stored in a communication state management DB;

FIGS. 12A to 12E are exemplary diagrams showing data configuration of a key generation request, a key generation response, key information, a key deletion request, and a key deletion response, respectively;

FIGS. 13A to 13D are each exemplary diagrams showing configuration of data that is stored in a key management DB;

FIGS. 14A to 14E are exemplary diagrams showing data configurations of a session information list acquisition request, a session information list acquisition response, session information, a key acquisition request, and a key acquisition response, respectively;

FIGS. 15A to 15E are exemplary diagrams showing data configurations of data that is stored in a packet DB in the first embodiment, a packet acquisition request, a packet acquisition response, a packet transmission end notification, and an encrypted packet, respectively;

FIGS. 16A and 16B are exemplary diagrams showing a session information search window and a session information search result window, respectively, which are displayed by an auditing application;

FIG. 17 is an exemplary diagram showing function configurations of devices that constitute a communications audit support system according to a second embodiment of the present invention;

FIG. 18 is a sequence exemplary diagram (1) showing how the communications audit support system of the second embodiment operates at the start of an encrypted communication session;

FIG. 19 is a sequence exemplary diagram (2) showing how the communications audit support system of the second embodiment operates at the start of the encrypted communication session;

FIG. 20 is a sequence exemplary diagram showing how the communications audit support system of the second embodiment operates at the end of an encrypted communication session;

FIG. 21 is a sequence exemplary diagram showing encrypted packet monitoring processing and real-time audit processing in the communications audit support system of the second embodiment;

FIGS. 22A to 22H are exemplary diagrams showing a configuration of an audit condition input window, which is displayed by the auditing application, and data configurations of an audit condition registration request, an audit condition registration response, an encrypted communication start notification, an encrypted communication start confirmation response, an encrypted communication end notification, an encrypted communication end confirmation response, and an audit requirement definition, respectively; and

FIGS. 23A to 23F are exemplary diagrams showing data configurations of data that is stored in an audit condition table, data that is stored in the packet DB in the second embodiment, a packet collection start request, a packet collection start response, a packet collection end request, and a packet collection end response, respectively.

### DESCRIPTION OF THE EMBODIMENTS

Embodiments of the present invention will be described below with reference to the accompanying drawings.

### First Embodiment

A first embodiment describes an example of applying the present invention to a communication system that employs Session Initiation Protocol (SIP). SIP is a communication protocol defined in RFC 3261 of IETF to manage and control communication sessions. A communications audit support system according to the present invention is applicable not only to communication systems that employ SIP but also to such communication systems that use a third party device to establish communication among multiple communication devices.

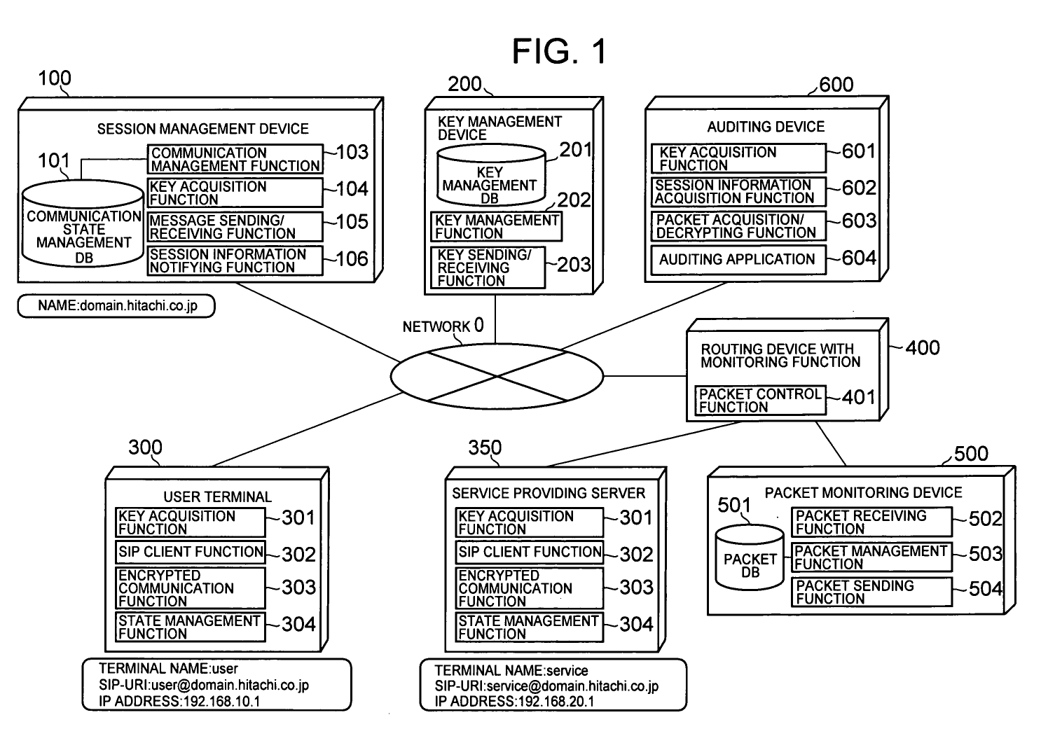

FIG. 1 is a system configuration diagram of a communications audit support system according to the first embodiment. The communications audit support system shown in FIG. 1 has a session management device 100, a key management device 200, a user terminal 300, a service providing server 350, a routing device 400 with a monitoring function, a packet monitoring device 500, and an auditing device 600.

The service providing server 350 and the packet monitoring device 500 are connected to the routing device 400 with a monitoring function. The routing device 400 with a monitoring function is connected to a network 0, such as the Internet or the like, and communicates with the session management device 100, the key management device 200, the user terminal 300, and the auditing device 600 via the network 0.

The user terminal 300 and the service providing server 350 in the first embodiment are uniquely identified by identifiers called SIP-URIs (Uniform Resource Identifiers). The SIP-URI of the user terminal 300 is expressed as a string of characters obtained by joining the name of the user terminal 300 and the name of the session management device 100 with “@” and then attaching “sip:” to the head of the resultant character string. The SIP-URI of the service providing server 350 is similarly expressed as a string of characters obtained by joining the name of the service providing server 350 and the name of the session management device 100 with “@” and then attaching “sip:” to the head of the resultant character string.

In the example of FIG. 1, when the name of the user terminal 300 is “user” and the name of the session management device 100 is “domain.hitachi.co.jp”, the SIP-URI of the user terminal 300 is “sip:user@domain.hitachi.co.jp”. Similarly, when the name of the service providing server 350 is “service”, the SIP-URI of the service providing server 350 is “sip:service@domain.hitachi.co.jp”. However, the SIP-URI naming rule is not limited to this. For instance, identification information of a user that is operating the user terminal 300 (a user name) may be employed instead of the name of the user terminal 300.

Processing in which the user terminal 300 or the service providing server 350 has a register DB store its own IP address and SIP-URI in association with the session management device 100 is defined in the first embodiment as a login operation of the user terminal 300 or the service providing server 350 to the session management device 100.

Described next are functions of the respective components of the communications audit support system in the first embodiment.

The session management device 100, which is a device that controls and manages encrypted communication between the user terminal 300 and the service providing server 350, has a communication state management database (DB) 101, a communication management function 103, a key acquisition function 104, a message sending/receiving function 105, and a session information notifying function 106. The key management device 200 has a key management DB 201, a key management function 202, and a key sending/receiving function 203. The packet monitoring device 500 has a packet DB 501, a packet receiving function 502, a packet management function 503, and a packet sending function 504.

The communication state management DB 101 is a database in which session information is registered. The communication management function 103 is used to register session information of an encrypted communication session between the user terminal 300 and the service providing server 350 in the communication state management DB 101, and to retrieve the session information from the communication state management DB 101. The key acquisition function 104 is used to obtain from the key management device 200 key information used for encrypted communication between the user terminal 300 and the service providing server 350, and to write the obtained key information into a message that is sent by the message sending/receiving function 105. The message sending/receiving function 105 is used to send or receive an SIP message between the user terminal 300 and the service providing server 350. The session information notifying function 106 is used to send session information to the auditing device 600.

Key information in the first embodiment contains a key used for encrypted communication, a key ID with which the key is uniquely identified, a validity period, and the name of an encrypting algorithm that uses the key. Session information in the first embodiment contains a session ID with which an encrypted communication is uniquely identified, a key ID used in the encrypted communication session, the names and IP addresses of communication devices that hold the encrypted communication session, and the start time and end time of the use of the key. Further, a session ID in this embodiment is constituted of the left-hand side characters which precede “@” in a string of characters within the Call-ID field written in an SIP message.

The key management device 200 is a device that generates and manages a key used for encrypted communication between the user terminal 300 and the service providing server 350, and has the key management DB 201, the key management function 202, and the key sending/receiving function 203.

The key management DB 201 is a database in which key information is registered. The key management function 202 is used to create key information, to register created key information in the key management DB 201, and to retrieve key information from the key management DB 201. The key sending/receiving function 203 is used to receive a key acquisition request or a key generation request, and to send key information to the issuer of the request.

The user terminal 300 is a device that performs an encrypted communication session with the service providing server 350 and the service providing server 350 is a device that performs an encrypted communication session with the user terminal 300. The user terminal 300 and the service providing server 350 each have a key acquisition function 301, an SIP client function 302, an encrypted communication function 303, and a state management function 304.

The key acquisition function 301 is for obtaining key information to be used in an encrypted communication session from an SIP message received from the session management device 100, monitoring the validity period of the obtained key information, and deleting the used key information after the encrypted communication session is ended. The SIP client function 302 is used to perform SIP communication for establishing an encrypted communication session with another user terminal 300 or service providing server 350 via the session management device 100.

The encrypted communication function 303 is used to receive an encrypted packet from a party on the other end of an established communication session, to decrypt the received encrypted packet, and to encrypt a packet before sending the packet to a party on the other end of an established communication session. The state management function 304 is used to manage the internal states of its own device and a device on the other end of a communication session which are managed by their respective SIP client functions 302.

In this embodiment, the state management function 304 in the user terminal 300 displays the internal state of the user terminal 300 on a screen connected to the user terminal 300, whereas the state management function 304 in the service providing server 350 outputs the internal state of the service providing server 350 as an event log.

The routing device 400 with a monitoring function has a packet control function 401, which is used to receive an encrypted packet exchanged between the user terminal 300 and the service providing server 350, to copy the received encrypted packet before sending the received encrypted packet to its intended destination, and to send the copy of the encrypted packet to the packet monitoring device 500.

The packet monitoring device 500 is provided with the packet DB 501, the packet receiving function 502, the packet management function 503, and the packet sending function 504. The packet DB 501 is a database that stores an encrypted packet received from the routing device 400 with a monitoring function in association with the sender and destination of the encrypted packet. The packet receiving function 502 is used to receive an encrypted packet from the routing device 400 with a monitoring function.

The packet management function 503 is used to store an encrypted packet received by the packet receiving function 502 in the packet DB 501, and to retrieve an encrypted packet that is requested by the auditing device 600 from the packet DB 501. The packet sending function 504 is used to send to the auditing device 600 an encrypted packet that is obtained by the packet management function 503 from the packet DB 501.

The auditing device 600 is a device that audits communications exchanged in an encrypted communication session between the user terminal 300 and the service providing server 350. The auditing device 600 has a key acquisition function 601, a session information acquisition function 602, a packet acquisition/decrypting function 603, and an auditing application 604.

The key acquisition function 601 is used to obtain from the key management device 200 a key used for encrypted communication between the user terminal 300 and the service providing server 350. The session information acquisition function 602 is used to obtain a list of session information from the session management device 100. The packet acquisition/decrypting function 603 is used to obtain an encrypted packet from the packet monitoring device 500 and to decrypt the encrypted packet with a key obtained from the key management device 200. The auditing application 604 is used to audit encrypted communications exchanged between the user terminal 300 and the service providing server 350 with the use of the decrypted packet.

The communications audit support system to which the first embodiment is applied can be employed not only for auditing of client-server communication where the user terminal 300 and the service providing server 350 communicate with each other but also for auditing of communication between one service providing server 350 and another service providing server 350. In addition, the present invention is not limited to the configuration of the first embodiment in which the service providing server 350 is connected to the routing device 400 with a monitoring function.

For instance, the user terminal 300 may instead be connected to the routing device 400 with a monitoring function. In that case, replacing the service providing server 350 with the user terminal 300 in the system configuration of FIG. 1 makes it possible to employ the communications audit support system in the case where an encrypted communication session is to be performed with the user terminal 300 and the service providing server 350 that are connected directly to the network 0. Then, auditing of encrypted communications in this case focuses on the user terminal 300 that is connected to the routing device 400 with a monitoring function.

The network 0 is not limited to a private network such as a corporate LAN and may be an open network such as the Internet. Further, the routing device 400 with a monitoring function can be any device that has a function of relaying communication, typical examples of which are a repeater hub that does not have a switching function, a switching hub that has a mirroring port function, a router, a firewall, and a proxy server. In the case where a firewall is employed as the routing device 400 with a monitoring function, for example, communication between the inside and outside of an organization via the firewall can be audited.

The communication state management DB 101, which, as in the first embodiment, can be an internal device of the session management device 100, may be placed in devices other than the session management device 100 to be connected with the session management device 100 through a network. Similarly, the key management DB 201 may be placed in devices other than the key management device 200. Further, the packet DB 501 may be placed in devices other than the packet monitoring device 500.

The session management device 100, the key management device 200, the packet monitoring device 500, and the auditing device 600 in the first embodiment are separate devices as shown in FIG. 1, but the present invention is not limited thereto. The key management device 200 and the session management device 100 may be one device, or the auditing device 600 and the session management device 100 may be one device, or the packet monitoring device 500 and the auditing device 600 may be one device.

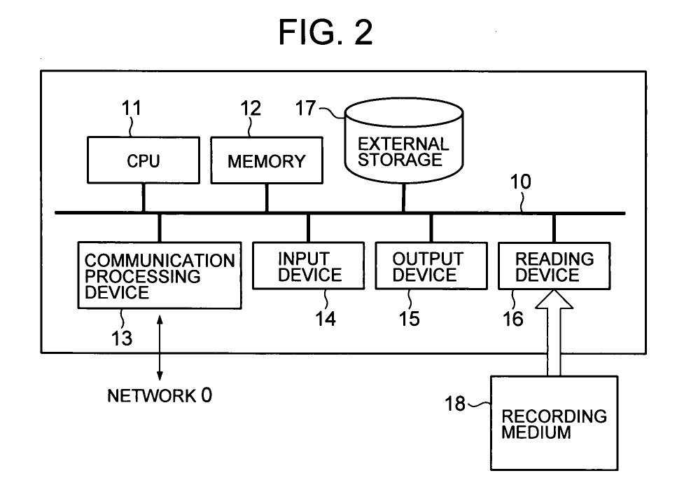

FIG. 2 shows as an example the configuration of a computer that implements functions of the session management device 100, the key management device 200, the user terminal 300, the service providing server 350, the packet monitoring device 500, or the auditing device 600.

The computer has a central processing unit (CPU) 11, a memory 12, a communication processing device 13, an input device 14, an output device 15, a reading device 16, and external storage 17, which are connected to one another via a bus 10.

The communication processing device 13 communicates with other communication devices through the Internet or a LAN. The input device 14 is, for example, a keyboard and/or a mouse. The output device 15 is, for example, a monitor and/or a printer. The reading device 16 reads data from a portable recording medium 18 such as an IC card or a USB memory. The external storage 17 is, for example, a hard disk.

Functions in the session management device 100, the key management device 200, the user terminal 300, the service providing server 350, the packet monitoring device 500, or the auditing device 600 in the first embodiment are carried out by loading programs that implement these functions, into the memory 12 and running the programs through the CPU 11.

These programs may be stored in advance in the external storage 17 of the computer described above, or may be obtained as the need arises from other devices through the reading device 16 or the communication processing device 13 in the form of a medium that can be used by the computer to be stored in the external storage 17. The medium refers to, for example, the recording medium 18 which can be loaded to and unloaded from the reading device 16, or the network 0, which can be connected to the communication processing device 13, or carrier waves or digital signals transmitted over the network 0.

After being temporarily stored in the external storage 17, the programs may be loaded into the memory 12 from the external storage 17 to be executed by the CPU 11. Alternatively, the programs may be directly loaded into the memory 12 and executed by the CPU 11 without ever being stored in the external storage 17. The communication state management DB 101, the key management DB 201, or the packet DB 501 is implemented by the memory 12 utilizing the external storage 17.

Described next is the operation of the communications audit support system using SIP in the first embodiment. The login operation of the user terminal 300 and the service providing server 350, to the session management device 100, is the same as the operation (e.g., registration) of normal systems that use SIP, and a description thereof will be omitted.

Through the login operation of the user terminal 300 and the service providing server 350, to the session management device 100, the session management device 100 stores the SIP-URIs and IP addresses of the user terminal 300 and the service providing server 350 in the memory 12 in a manner that associates their respective SIP-URIs with their respective IP addresses. Once the user terminal 300 and the service providing server 350 log into the session management device 100, encrypted communication can be established between the user terminal 300 and the service providing server 350, and the key management device 200 becomes ready to manage a key used for encrypted communication between the user terminal 300 and the service providing server 350. The auditing device 600 needs to obtain an encrypted packet and a key used for encrypted communication, and decrypt the packet, to thereby enable audit communications of an encrypted communication session between the user terminal 300 and the service providing server 350.

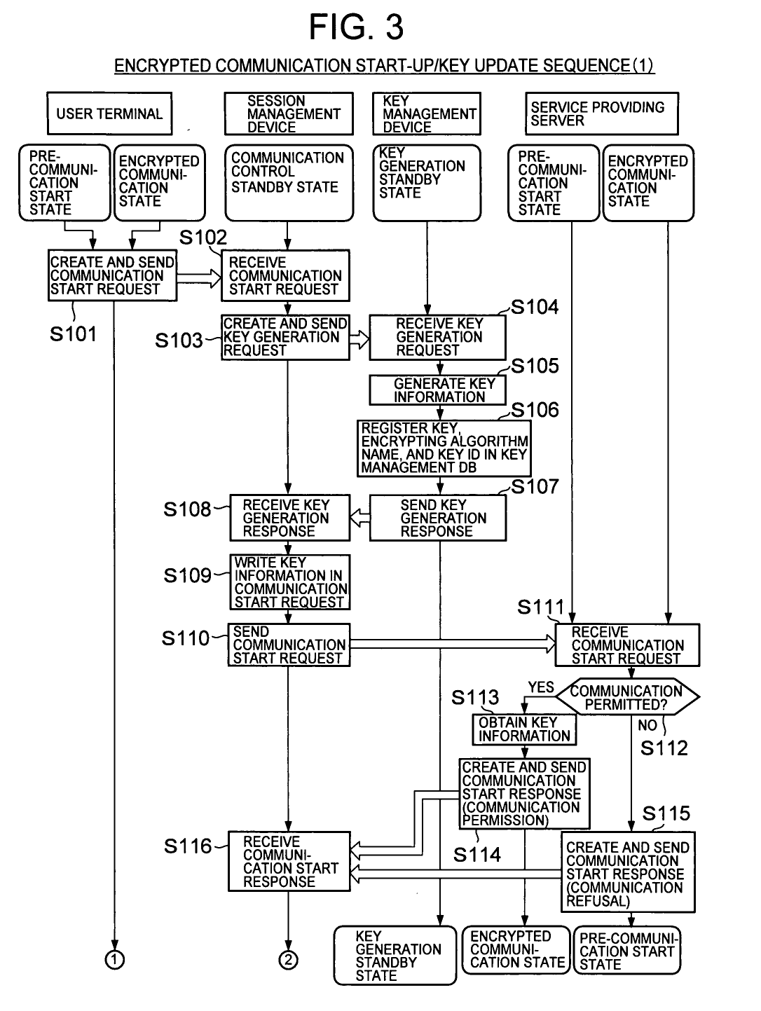

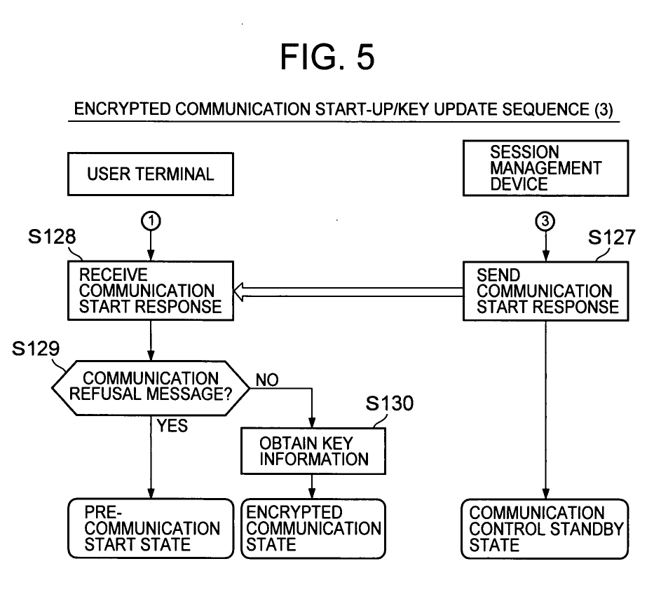

First, a description will be given, with reference to FIGS. 3 to 5, of the sequence of a series of operation steps in which the user terminal 300 shares, with the service providing server 350, through the session management device 100, a key to be used for encrypted communication, and starts an encrypted communication session.

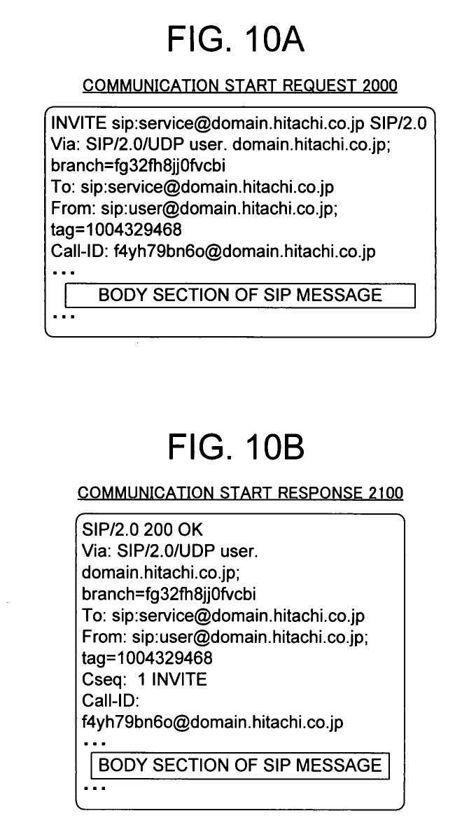

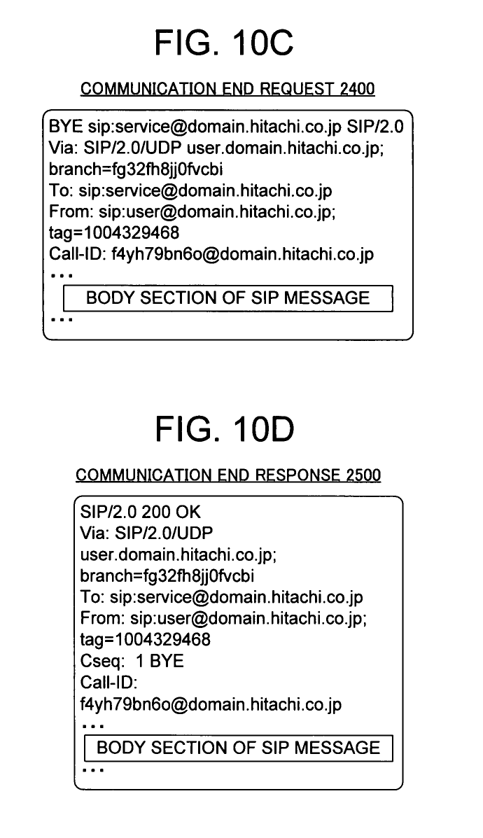

A person operating the user terminal 300 looks at a GUI window of the state management function 304 to confirm that the internal state of the user terminal 300 is “logged-in”, and then instructs the user terminal 300 to start processing for encrypted communication with the service providing server 350. The SIP client function 302 of the user terminal 300 creates a communication start request 2000 for communication with the service providing server 350, and sends the created request to the session management device 100 (Step S101). The communication start request 2000 created by the SIP client function 302 in the first embodiment is, for example, a request message of INVITE defined in SIP as shown in FIG. 10A.

The message sending/receiving function 105 of the session management device 100 receives the communication start request 2000 from the user terminal 300 (Step S102).

The key acquisition function 104 creates a key generation request 2200 containing the SIP-URI of the user terminal 300 which is written in the From field of the communication start request 2000 and the SIP-URI of the service providing server 350 which is written in the request's To field, and sends the created key generation request 2200 to the key management device 200 (Step S103).

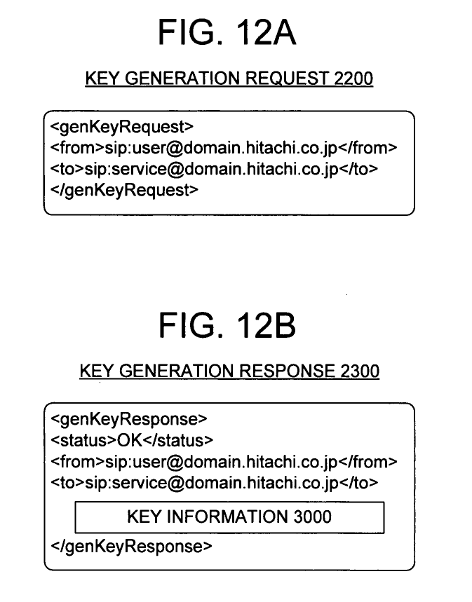

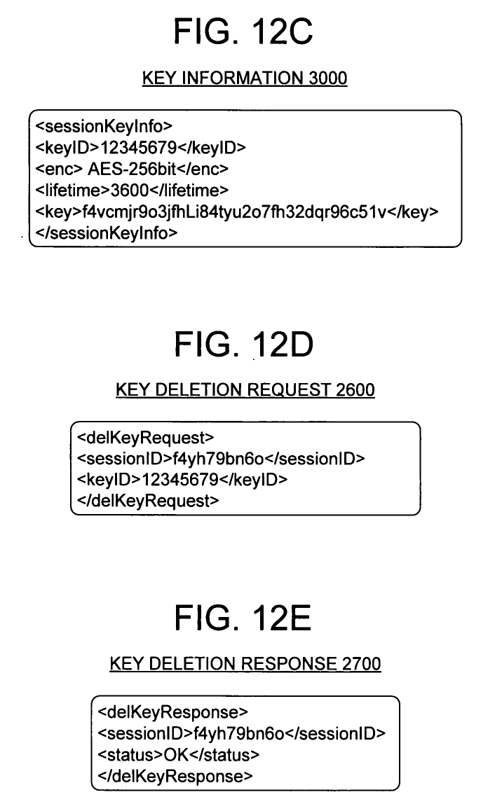

The key generation request 2200 in the first embodiment is written as, for example, a genKeyRequest tag of an XML message as shown in FIG. 12A. FIG. 12A shows only a part of the key generation request 2200 sent from the session management device 100 to the key management device 200 that is necessary to explain this embodiment. The SIP-URI of the user terminal 300, which is the sender of the communication start request 2000, is written in a “from” tag of the key generation request 2200, and the SIP-URI of the service providing server 350, which is the receiver of the communication start request 2000, is written in a “to” tag of the key generation request 2200.

The key sending/receiving function 203 of the key management device 200 receives the key generation request 2200 from the session management device 100 (Step S104). The key management function 202 creates key information 3000 (Step S105), and registers a part of the key information 3000, namely, a key ID, a key, and the name of an encrypting algorithm to be used, in the key management DB 201 (Step S106).

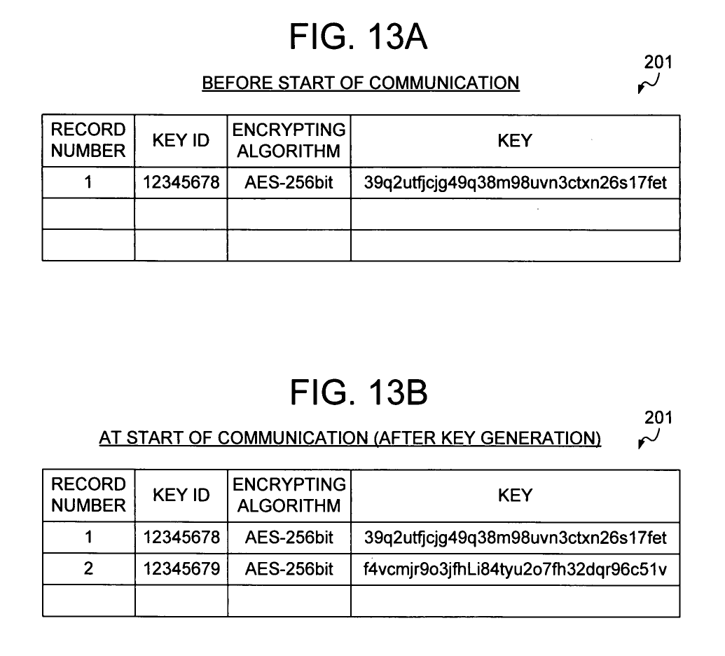

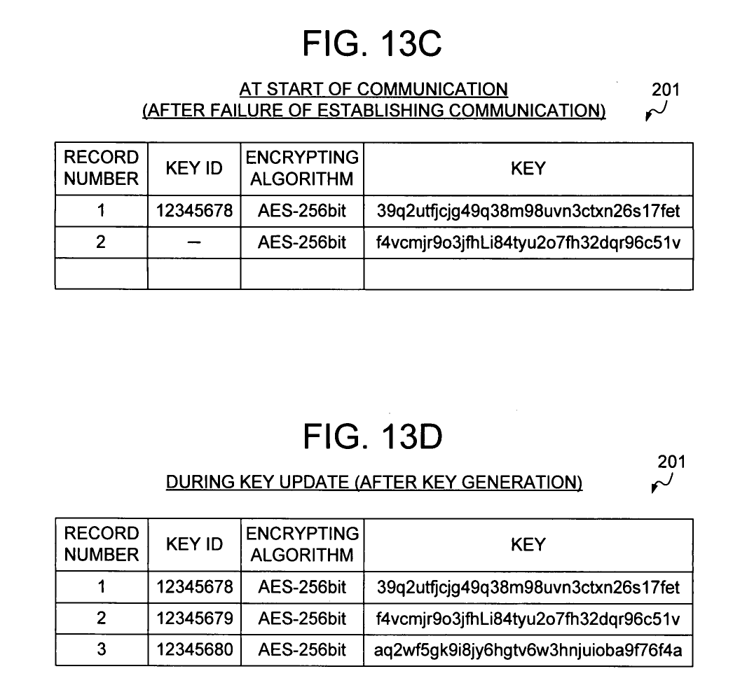

The key management DB 201 in the first embodiment holds records each containing a key ID, an encrypting algorithm, and a key as shown in FIGS. 13A to 13D. The key management DB 201 stores minimum information necessary for the auditing device 600 to obtain a key. The encrypting algorithm field in the key management DB 201 also holds such information as the bit count of the key and the version of the encrypting algorithm.

FIG. 13A shows the key management DB 201 before Step S106 is executed. In the key management DB 201 at this stage, a key ID is “12345678” and a key whose encrypting algorithm is “AES-256 bit” is registered. FIG. 13B shows a key generated and additionally registered in the key management DB 201 as a result of the execution of Step S106. The added key has a key ID “12345679” and an encrypting algorithm “AES-256 bit”.

Back to FIG. 3, the key sending/receiving function 203 creates a key generation response 2300, attaches the key information 3000 created in Step S105 to the key generation response 2300, and sends the key generation response 2300 to the session management device 100 (Step S107).

The key generation response 2300 in the first embodiment is written as, for example, a genKeyResponse tag of an XML message as shown in FIG. 12B. FIG. 12B shows only a part of the key generation response 2300 sent from the key management device 200 to the session management device 100 that is necessary to explain this embodiment. Written in a status tag component of the key generation response 2300 is the result of registration by the key management device 200 in the key management DB 201 of a key ID, a key, and an encrypting algorithm name that are used in an encrypted communication session between the user terminal 300 and the service providing server 350.

When the registration succeeds, “OK” is written in the status tag component of the key generation response 2300 whereas “NG” is written when the registration fails. The SIP-URI of the user terminal 300, which is the sender of the key generation request 2200, is written in a “from” tag component of the key generation response 2300 and the SIP-URI of the service providing server 350, which is the receiver of the key generation request 2200, is written in a “to” tag component of the key generation response 2300. Also, the created key information 3000 is written in the XML format in the key generation response 2300.

The key information 3000 is expressed as a sessionKeyInfo tag in the XML format. The key information 3000 contains, for example, as shown in FIG. 12C, a keyID tag in which a key ID used in an encrypted communication session between the user terminal 300 and the service providing server 350 is written, an enc tag in which the name of an algorithm used to encrypt data is written, a lifetime tag in which the validity period of a key used in the encrypted communication session is written, and a key tag in which the key is written. A numeric value written in the lifetime tag in the first embodiment indicates time measured in seconds.

In Step S108 of FIG. 3, the key acquisition function 104 of the session management device 100 receives the key generation response 2300 sent from the key management device 200 in Step S107. The key acquisition function 104 stores the key information 3000 in the memory 12 in association with a session ID written in the Call-ID field of the communication start request 2000, and writes the key information 3000 in a BODY section of the communication start request 2000 shown in FIG. 10A (Step S109). The message sending/receiving function 105 sends the communication start request 2000 to the service providing server 350 (Step S110).

The communication start request 2000 that is sent or received in Step S110 and subsequent steps is one obtained by writing the key information 3000, which is described in the XML format, in the BODY session of the communication start request 2000 that is shown in FIG. 10A.

The SIP client function 302 of the service providing server 350 receives the communication start request 2000 from the session management device 100 (Step S111), and examines the received communication start request 2000 to judge whether or not communication with the user terminal 300 is possible (Step S112). When encrypted communication with the user terminal 300 is to be denied, the SIP client function 302 of the service providing server 350 creates a communication start response 2100 that contains a message to the effect that the communication request is refused, and sends the created response to the session management device 100 in response to the communication start request 2000 (Step S115). The state management function 304 outputs an event recording the refusal of the communication request from the user terminal 300 to an event log. An administrator of the service providing server 350 recognizes the fact that an encrypted communication session with the user terminal 300 has been denied by checking the event log.

A message employed in the first embodiment as the message stating that a communication request is denied is the “401 Unauthorized” message of the INVITE response defined in SIP.

On the other hand, when encrypted communication with the user terminal 300 is to be permitted in Step S112, the key acquisition function 301 of the service providing server 350 obtains the key information 3000 written in the BODY section of the communication start request 2000 (Step S113), and stores the key information 3000 in the memory 12 in association with the session ID written in the Call-ID field of the communication start request 2000.

The SIP client function 302 creates the communication start response 2100 that contains a message to the effect that communication is permitted, and sends the created response to the session management device 100 in response to the communication start request 2000 (Step S114). The state management function 304 then shifts the internal state of the service providing server 350 to an encrypted communication state, and outputs an event recording the start of encrypted communication with the user terminal 300, to the event log. The administrator of the service providing server 350 recognizes that the processing of starting encrypted communication with the user terminal 300 has been completed normally by checking the event log.

For the communication start response 2100 that contains the message saying that the communication is permitted, the first embodiment employs, for example, as shown in FIG. 10B, the “200OK” message of the INVITE response defined in SIP.

After Step S114 or Step S115, the message sending/receiving function 105 of the session management device 100 receives the communication start response 2100 from the service providing server 350 (Step S116), examines the communication start response 2100, and judges whether or not the communication start request 2000 made by the user terminal 300 to request communication with the service providing server 350 has been permitted (Step S117).

When the communication start response 2100 contains a message of refusal of communication, the key acquisition function 104 of the session management device 100 extracts a key ID from the key information 3000 stored in the memory 12 to create a key deletion request 2600, and sends the created key deletion request 2600 to the key management device 200 (Step S122).

The key deletion request 2600 in the first embodiment is written as, for example, a delKeyRequest tag of an XML message as shown in FIG. 12D. FIG. 12D shows only a part of the key deletion request 2600 sent from the session management device 100 to the key management device 200, that is necessary to explain this embodiment. The key deletion request 2600 contains a sessionID tag and a keyID tag. Written in the sessionID tag are left-hand side characters which precede “@” in a string of characters within the Call-ID field written in the communication start response 2100. Further, information in the keyID tag of the key information 3000 is written in the keyID tag of the key deletion request 2600.

The key sending/receiving function 203 of the key management device 200 receives the key deletion request 2600 from the session management device 100 (Step S123). The key management function 202 deletes the key ID that is written in the keyID tag of the key deletion request 2600 from the key management DB 201, thereby REVOKing the key ID (Step S124). Thereafter, the key sending/receiving function 203 creates a key deletion response 2700 and sends the created response to the session management device 100 (Step S125).

Information stored in the key management DB 201 is thus updated, for example, from a state shown in FIG. 13B to a state shown in FIG. 13C. When deleting a key ID in Step S124, the key management function 202 may also delete from the key management DB 201 an encrypting algorithm and a key that are associated with the key ID.

The key deletion response 2700 in the first embodiment is written as a delKeyResponse tag of an XML message. FIG. 12E shows only a part of the key deletion response 2700 sent from the key management device 200 to the session management device 100 that is necessary to explain this embodiment. The key deletion response 2700 contains a sessionID tag and a status tag. Written in the status tag is the result of deletion of a key ID, a key, and an encrypting algorithm name from the key management DB 201 by the key management function 202. When the deletion succeeds, “OK” is written in the status tag whereas “NG” is written in the status tag when the deletion fails.

The key acquisition function 104 of the session management device 100 receives the key deletion response 2700 sent from the key management device 200 (Step S126), and deletes a session ID and key information that have been stored in the memory 12. The message sending/receiving function 105 creates the communication start response 2100 and sends the created response to the user terminal 300 (Step S127).

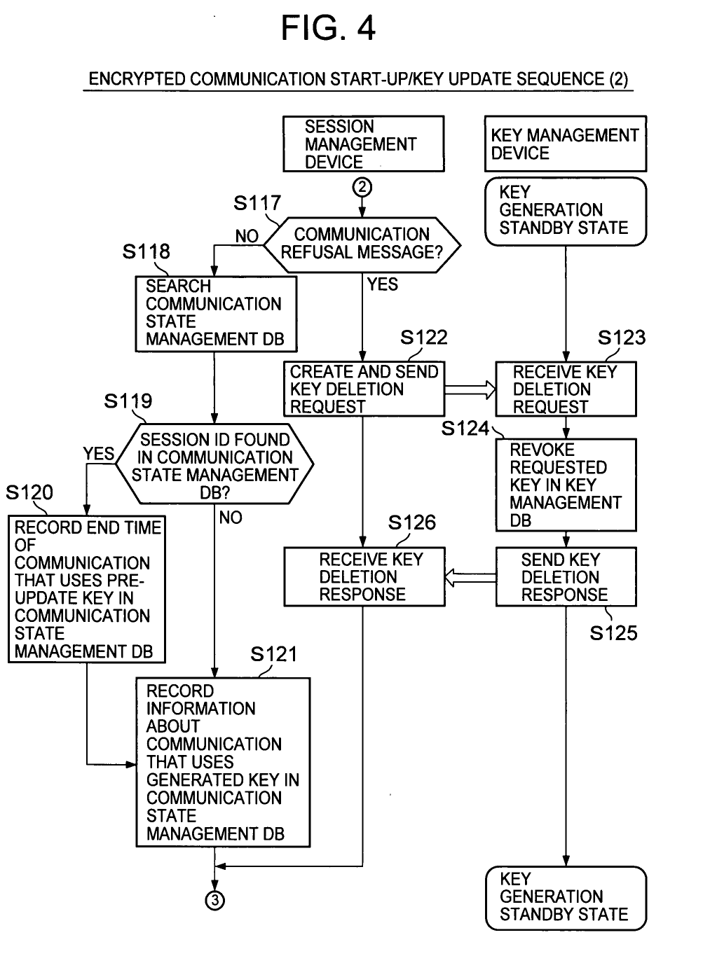

After Step S117 of FIG. 4, in the case where the communication start response 2100 contains a message permitting communication, the communication management function 103 of the session management device 100 uses as a key a session ID that is written in the Call-ID field of the communication start response 2100 to search the communication state management DB 101 for a record that has the session ID (Step S118). The communication management function 103 in the first embodiment judges that an encrypted communication session is established when a message that permits encrypted communication is received from a communication device on the other end of the encrypted communication session.

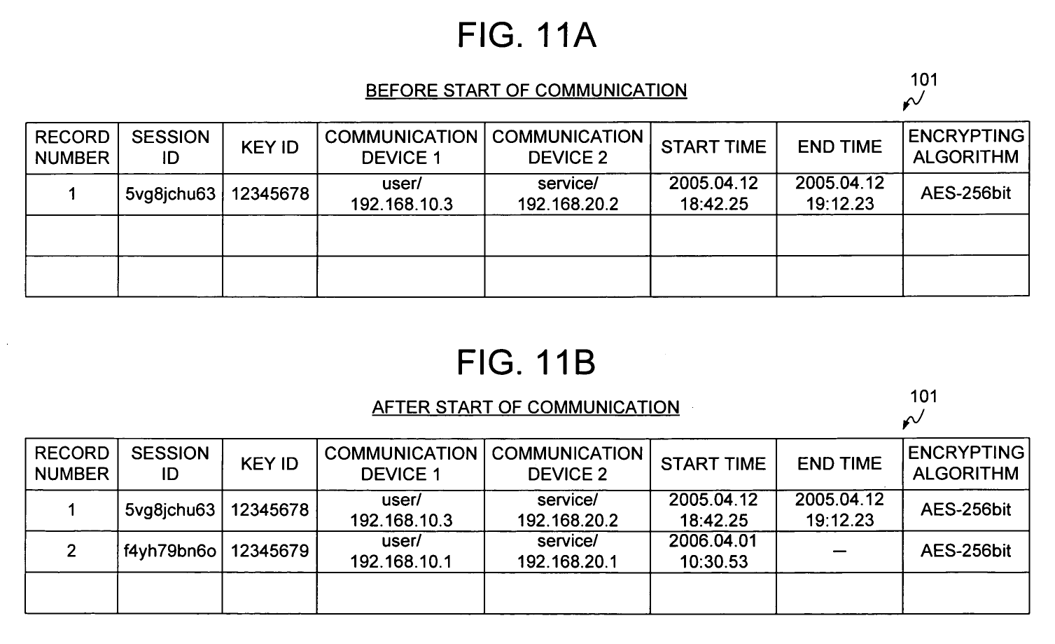

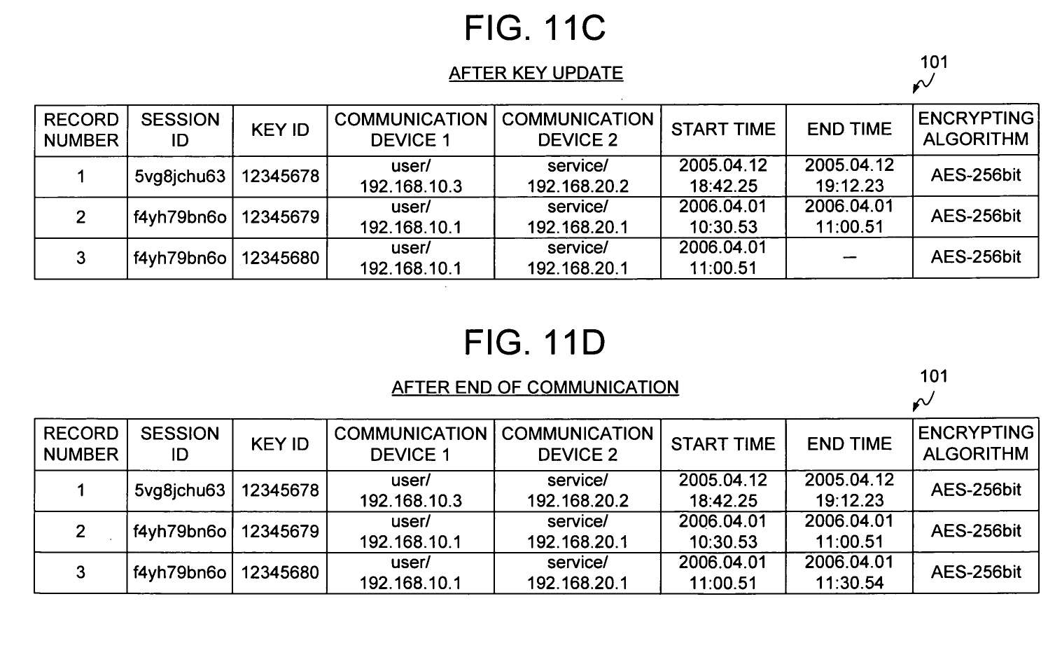

The communication state management DB 101 in the first embodiment stores, for example, as shown in FIG. 11, a key ID, a communication device 1, which refers to a communication device that requests to start a communication session, a communication device 2, which is a communication device that communicates with the communication device 1, a communication start time, a communication end time, and an encrypting algorithm in association with a session ID. It is assumed in the first embodiment that the communication state management DB 101 prior to the execution of Step S118 in FIG. 3 stores such information as shown in FIG. 11A.

A communication manager or other authorized personnel can know what communication session is taking place and check whether a communication policy (e.g., using a set encrypting algorithm for encrypted communication) is being followed by the single action of referring to the communication state management DB 101. In addition, since the communication state management DB 101 in the first embodiment associates a key ID not only with the IP addresses of communication devices performing an encrypted communication session but also with a time slot in which the encrypted communication session is performed, a communication device can be identified uniquely by an IP address associated with a specific time slot even when IP address allocation is dynamically changed by Dynamic Host Configuration Protocol (DHCP) or the like.

In Step S119, the session ID that is written in the Call-ID field of the communication start response 2100 received in Step S116 (the session ID is “f4yh79bn6o” in the first embodiment) is not found in the communication state management DB 101, and the communication management function 103 accordingly judges that encrypted communication between the user terminal 300 and the service providing server 350 is a new communication session.

The communication management function 103 writes the session ID in the session ID cell of a record in the communication state management DB 101, writes, in the key ID cell of the record, a key ID written in the keyID tag of the key information 3000 that has been stored in the memory 12, writes, in the communication device 1 cell of the record, in association with the SIP-URI of the user terminal 300 which has been stored in the memory 12, the name of the user terminal 300 which is written in the From field of the communication start response 2100, writes, in the communication device 2 cell of the record, in association with the SIP-URI of the service providing server 350 which has been stored in the memory 12, the name of the service providing server 350 which is written in the To field of the communication start response 2100, writes the current time in the start time cell of the record, and writes, in the encrypting algorithm cell of the record, an encrypting algorithm name written in the enc tag of the key information 3000 (Step S121). As a result, information stored in the communication state management DB 101 now looks like that shown in FIG. 11B.

Thereafter, the key acquisition function 104 takes the key information 3000 out of the memory 12, writes the key information 3000 in the BODY section of the communication start response 2100 shown in FIG. 10B, and then deletes the session ID and the key information 3000 that have been stored in the memory 12. The message sending/receiving function 105 sends the communication start response 2100 created by the key acquisition function 104 to the user terminal 300 (Step S127).

The SIP client function 302 of the user terminal 300 receives the communication start response 2100 from the session management device (Step S128), and checks the received communication start response 2100 (Step S129). When the communication start response 2100 contains a message of refusal of communication, the state management function 304 of the user terminal 300 displays in the GUI window a message to the effect that communication with the service providing server 350 is denied. The person operating the user terminal 300 recognizes the fact that encrypted communication with the service providing server 350 has been denied by looking at the GUI window.

When the communication start response 2100 contains a message permitting communication, the key acquisition function 301 of the user terminal 300 obtains the key information 3000 written in the BODY section of the communication start response 2100 (Step S130), and stores the key information 3000 in the memory 12 in association with a session ID written in the Call-ID field of the communication start response 2100. The state management function 304 then shifts the internal state of the user terminal 300 to “holding encrypted communication”, and has the GUI window display a message to the effect that encrypted communication with the service providing server 350 has started. The person operating the user terminal 300 recognizes the fact that processing of starting encrypted communication with the service providing server 350 has been completed normally by looking at the GUI window.

The user terminal 300 and the service providing server 350 then start encrypted communication using the obtained key information 3000 without the intervention of the session management device 100.

Described above is the operation sequence for starting an encrypted communication session in the first embodiment in which the user terminal 300 shares, with the service providing server 350, via the session management device 100, the key information 300 used in the encrypted communication session.

A series of operation steps for updating a key shared between the user terminal 300 and the service providing server 350 when the validity period of the key expires is the same as the operation sequence for starting encrypted communication except for Step S118 and subsequent steps of FIG. 4. In the key update sequence, however, the service providing server 350 always permits a request for encrypted communication. That is, since the communication start response 2100 in the key update sequence contains a message permitting communication, the communication management function 103 of the session management device 100 executes Step S118 after Step S117.

In Step S118, the communication management function 103 searches the communication state management DB 101 for a record whose session ID matches the one written in the Call-ID field of the communication start response 2100 and whose end time cell is blank. Information stored in the communication state management DB 101 prior to the execution of Step S118 is, for example, as shown in FIG. 11B. The communication management function 103 accordingly retrieves a record on the second row whose session ID cell holds the session ID it seeks and whose end time cell is blank (Step S19).

The communication management function 103 enters the current time in the end time cell of the second record in the communication state management DB 101 (Step S120), and writes, in a third record which has been blank, pertinent pieces of information including the session ID, the updated key ID, the name of the user terminal 300, the name of the service providing server 350, the start time (current time), and the encrypted algorithm (Step S121). As a result, information stored in the communication state management DB 101 now looks like that shown in FIG. 11C.

Step S127 and subsequent steps are then executed, and the user terminal 300 and the service providing server 350 continues encrypted communication using the obtained key information 3000 without the intervention of the session management device 100.

Described above is the operation sequence for updating a key shared between the user terminal 300 and the service providing server 350 in the first embodiment in cases where the key is to be updated upon expiration of its validity period. In the key update sequence, the communication start request 2000 that requests communication with the user terminal 300 may be sent from the service providing server 350 to the session management device 100. This does not change the key update sequence except that the positions of the user terminal 300 and the service providing server 350 in FIG. 3 are switched. Instead of updating a key when the validity period of the key expires, a key may be updated shortly before its validity period.

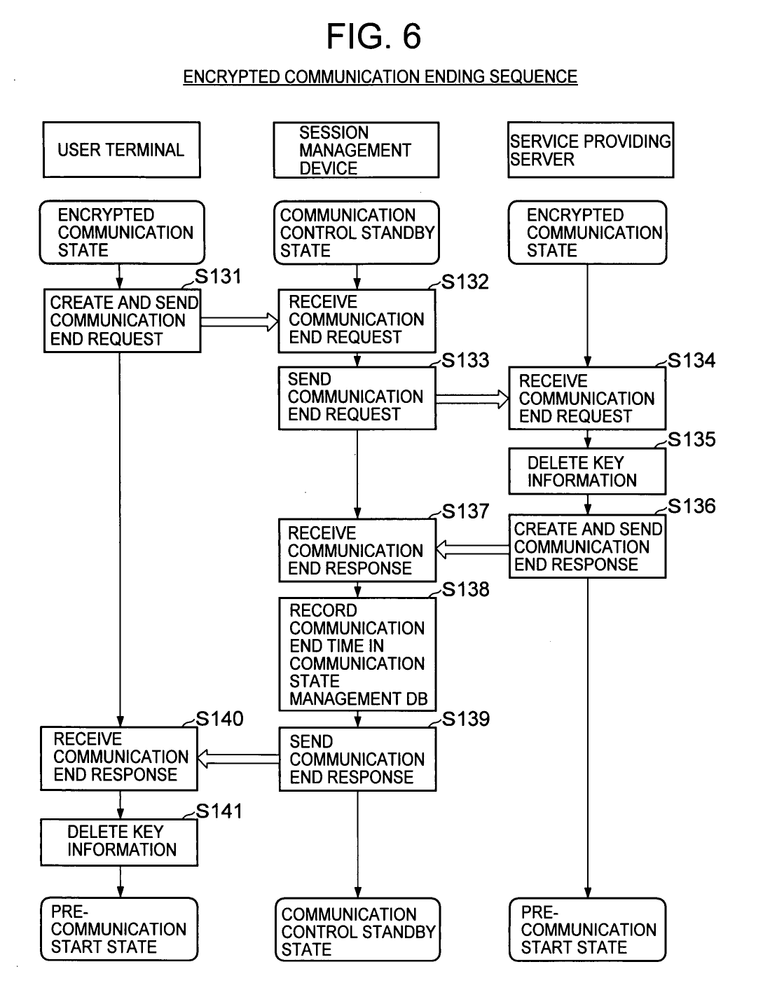

A description will be given next with reference to FIG. 6 on the sequence of a series of operation steps in which the user terminal 300 ends, via the session management device 100, an encrypted communication session with the service providing server 350.

The person operating the user terminal 300 looks at the GUI window of the state management function 304 to confirm that the internal state of the user terminal 300 is “performing encrypted communication” and, when the encrypted communication session is to be ended, instructs the user terminal 300 to end the processing of encrypted communication with the service providing server 350. The SIP client function 302 of the user terminal 300 creates a communication end request 2400 requesting an end of communication with the service providing server 350, and sends the created request to the session management device 100 (Step S131). A message employed in the first embodiment as the communication end request 2400 is, for example, the BYE request message defined in SIP as shown in FIG. 10C.

The message sending/receiving function 105 of the session management device 100 receives the communication end request 2400 from the user terminal 300 (Step S132), and sends the communication end request 2400 to the service providing server 350 (Step S133). The SIP client function 302 of the service providing server 350 receives the communication end request 2400 from the session management device 100 (Step S134). The key acquisition function 301 deletes from the memory 12 a session ID written in the Call-ID field of the communication end request 2400 and the key information 3000 (Step S135).

The SIP client function 302 then creates a communication end response 2500 and sends the created response to the session management device 100 (Step S136). The state management function 304 shifts the internal state of the service providing server 350 to “before start of communication”, and outputs to the event log an event recording the deletion of the key information 3000 used in the encrypted communication session with the user terminal 300 and an event recording the end of the encrypted communication session. The administrator of the service providing server 350 recognizes the fact that the processing of ending encrypted communication with the user terminal 300 has been completed normally by checking the event log.

A message employed in the first embodiment as the communication end response 2500 is, for example, the BYE response message defined in SIP as shown in FIG. 10D.

The message sending/receiving function 105 of the session management device 100 receives the communication end response 2500 from the service providing server 350 (Step S137 of FIG. 6). The communication management function 103 searches the communication state management DB 101 for a record whose session ID matches the one written in the Call-ID field of the communication end response 2500 and whose end time cell is blank. Information stored in the communication state management DB 101 at this point is, for example, as shown in FIG. 11C. The communication management function 103 accordingly retrieves a record on the third row of FIG. 11C as a search target.

Judging that the encrypted communication session between the user terminal 300 and the service providing server 350 has ended, the communication management function 103 enters the current time in the end time cell of the third record in the communication state management DB 101 (Step S138). As a result, information stored in the communication state management DB 101 now looks like that shown in FIG. 11D. Thereafter, the message sending/receiving function 105 sends the communication end response 2500 to the user terminal 300 (Step S139).

The SIP client function 302 of the user terminal 300 receives the communication end response 2500 from the session management device 100 (Step S140). The key acquisition function 301 deletes from the memory 12 the session ID written in the Call-ID field of the communication end response 2500 and the key information 3000 (Step S141). The state management function 304 shifts the internal state of the user terminal 300 to “before start of communication”, and displays in the GUI window a message to the effect that the key information 3000 used in the encrypted communication session with the service providing server 350 has been deleted and a message to the effect that the encrypted communication session has ended. The person operating the user terminal 300 recognizes the fact that the processing of ending encrypted communication with the service providing server 350 has been completed normally by looking at the GUI window.

Described above is the operation sequence in which the user terminal 300 ends via the session management device 100 an encrypted communication session with the service providing server 350. In the communication ending sequence, the communication end request 2400 that requests to end communication with the user terminal 300 may be sent from the service providing server 350 to the session management device 100. This does not change the communication ending sequence except that the positions of the user terminal 300 and the service providing server 350 in FIG. 6 are switched. The series of communication ending operation steps may be executed when the validity period of a key is expired in the case where a key is updated upon expiration of its validity period.

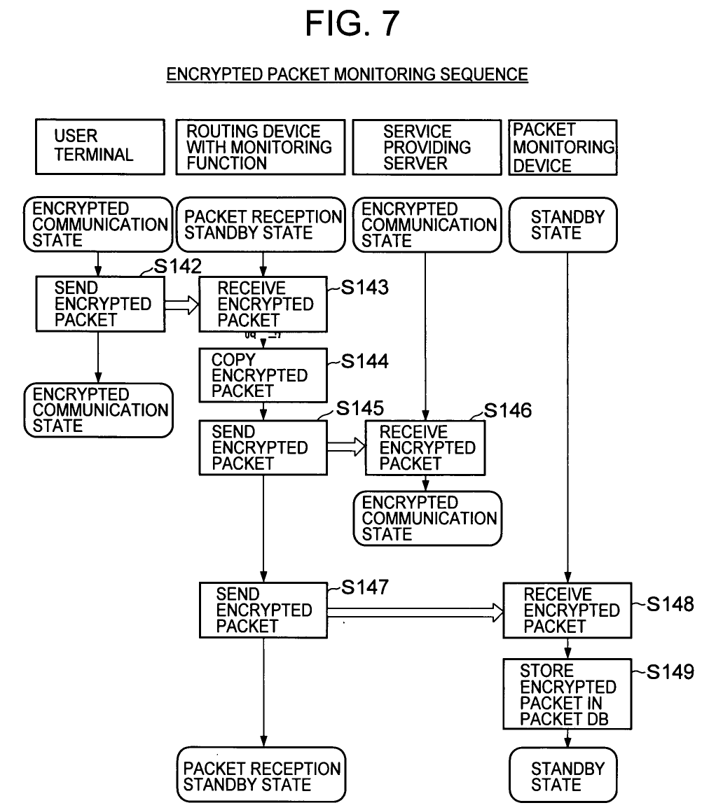

A description will be given next with reference to FIG. 7 on the sequence of a series of operation steps in which the user terminal 300 and the service providing server 350 exchange an encrypted packet after starting an encrypted communication session. Note that FIG. 7 illustrates only a case of sending an encrypted packet from the user terminal 300 to the service providing server 350.

The user terminal 300, the internal state of which is “performing encrypted communication”, sends an encrypted packet to the service providing server 350 (Step S142). The packet control function 401 of the routing device 400 with a monitoring function receives the encrypted packet from the user terminal 300 (Step S143), duplicates the received encrypted packet (Step S144), and sends the two encrypted packets to the service providing server 350 and the packet monitoring device 500, respectively (Steps S145 and S147).

The service providing server 350 receives the encrypted packet that has been sent in Step S145 from the routing device 400 with a monitoring function (Step S146), and decrypts the encrypted packet with the key information 3000 stored in the memory 12.

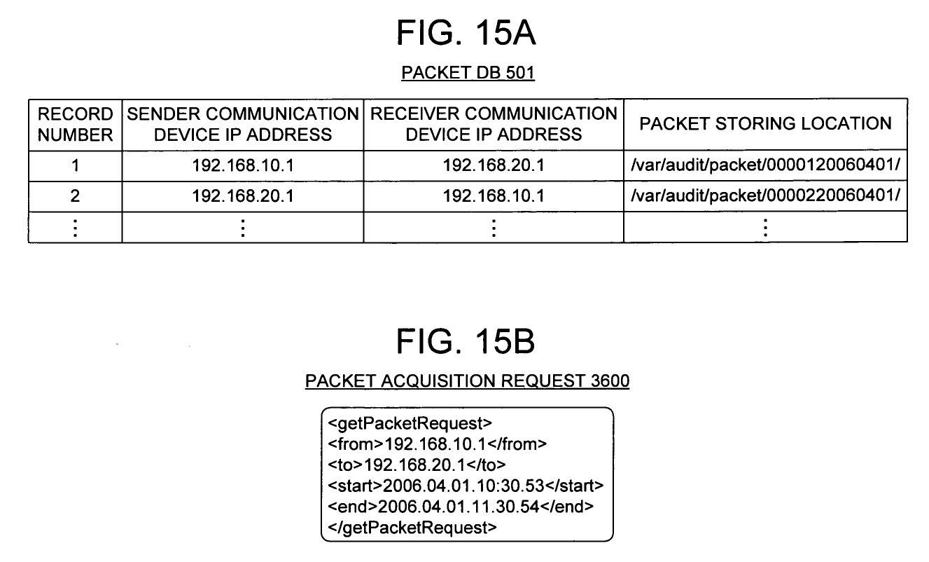

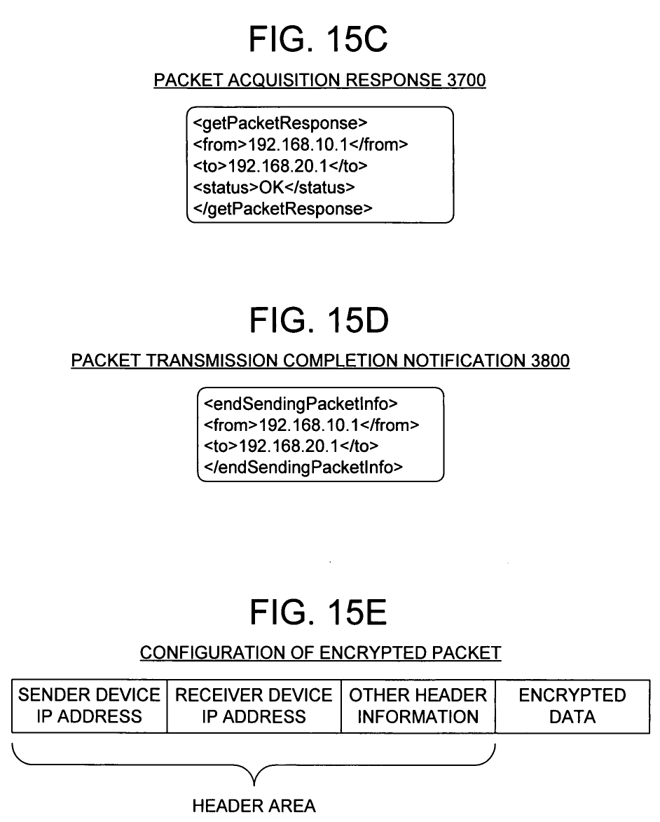

The packet monitoring device 500 receives the encrypted packet that has been sent in Step S147 from the routing device 400 with a monitoring function (Step S148), and examines information stored in the header area of the encrypted packet shown in FIG. 15E. The packet monitoring device 500 checks the sender IP address and the destination IP address, and then stores the encrypted packet in a location written in a packet storing location cell of the packet DB 501 (Step S149).

The packet DB 501 in the first embodiment has a table that shows, for each combination of the IP addresses of a sender communication device and a receiver communication device which hold an encrypted communication session, where to store an encrypted packet exchanged between the sender and receiver communication devices. The packet management function 503 looks up the table using header information of a received encrypted packet, and stores the encrypted packet in a location that is indicated by the table as the intended storage place of the encrypted packet.

For instance, when the header area of an encrypted packet sent from the user terminal 300 to the service providing server 350 stores “192.168.10.1” as the IP address of the sender communication device (the user terminal 300) and “192.168.20.1” as the IP address of the receiver communication device (the service providing server 350), the packet management function 503 stores the encrypted packet in a directory identified by “/var/audit/packet/0000120060401” in the example of FIG. 15A.

The packet management function 503 creates a directory identified by identification information which is, for example, a combination of a character string (e.g., a five-digit number) for identifying a combination of a sender communication device IP address and a receiver communication device IP address and a character string that indicates the date. In the case where two encrypted packets that have the same combination of sender and receiver IP addresses sent on the same day, these encrypted packets are stored in the same directory.

Described above is the operation sequence in which an encrypted packet is exchanged between the user terminal 300 and the service providing server 350. In the encrypted packet monitoring sequence, an encryption packet may be sent from the service providing server 350 to the user terminal 300. This does not change the encrypted packet monitoring sequence except that the positions of the user terminal 300 and the service providing server 350 in FIG. 7 are switched. In Step S149 of the modified sequence, the packet monitoring device 500 receives an encrypted packet sent from the service providing server 350 to the user terminal 300, and stores the received packet in a directory that is identified by “/var/audit/packet/0000220060401” in the packet DB 501.

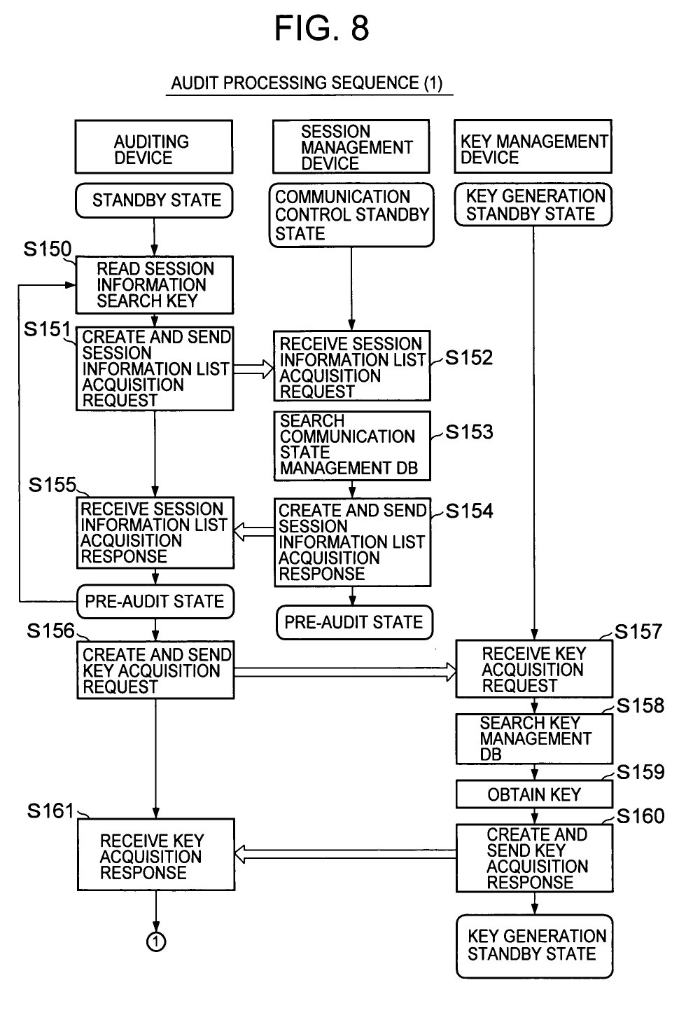

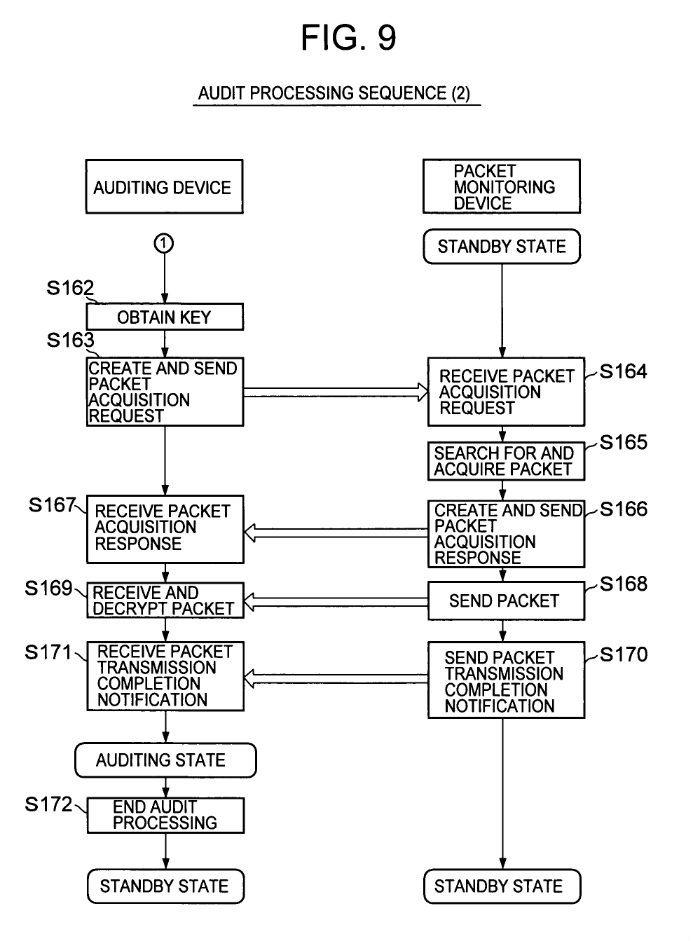

A description will be given next, with reference to FIGS. 8 and 9, of the sequence of a series of operation steps in which the auditing device 600 obtains a stored encrypted packet from the DB 501 after an encrypted communication session is ended, and decrypts the encrypted packet to audit the contents of the packet.

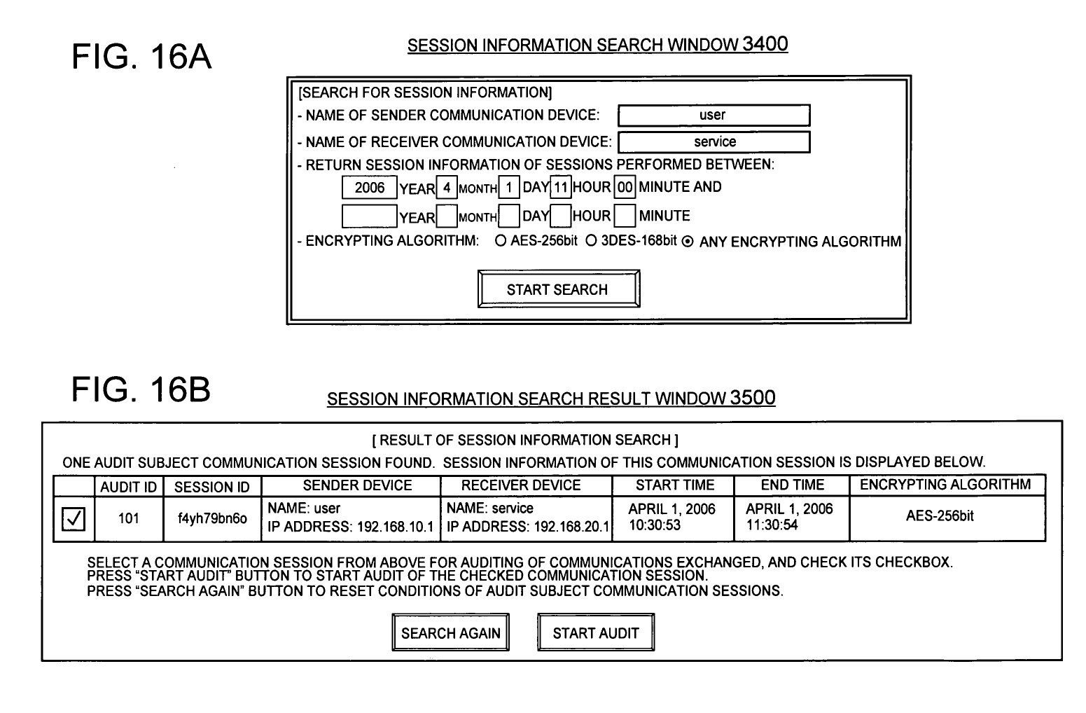

An auditor who operates the auditing device 600 obtains session information of a communication session to be audited from the session management device 100 by entering a search key in a session information search window 3400 of FIG. 16A which is displayed by the auditing application 604 of the auditing device 600. The auditing application 604 reads the entered search key (Step S150).

A search key entered by the auditor in the session information search window 3400 in the first embodiment is composed of the names of the sender communication device and receiver communication device which hold an encrypted communication session, a time slot for the encrypted packet transmission time, and the name of an encrypting algorithm used in the encrypted communication session. In the example of FIG. 16A, the auditor specifies an encrypted packet sent after 11:00 on Apr. 1, 2006 from a communication device that is named “user” to a communication device that is named “service”.

It should be noted that the fields for specifying the names of the communication devices and a time slot of the communication time may be blank. As to a search key field in which no entry is made, it is judged that the auditor has not specified any condition. In cases where all search key fields are blank, the auditing application 604 searches for session information with every past communication session as the audit subject.

The session information acquisition function 602 of the auditing device 600 stores the search key entered in the session information search window 3400 in the memory 12. The session information acquisition function 602 then creates a session information list acquisition request 2800 and sends the request to the session management device 100 (Step S151).

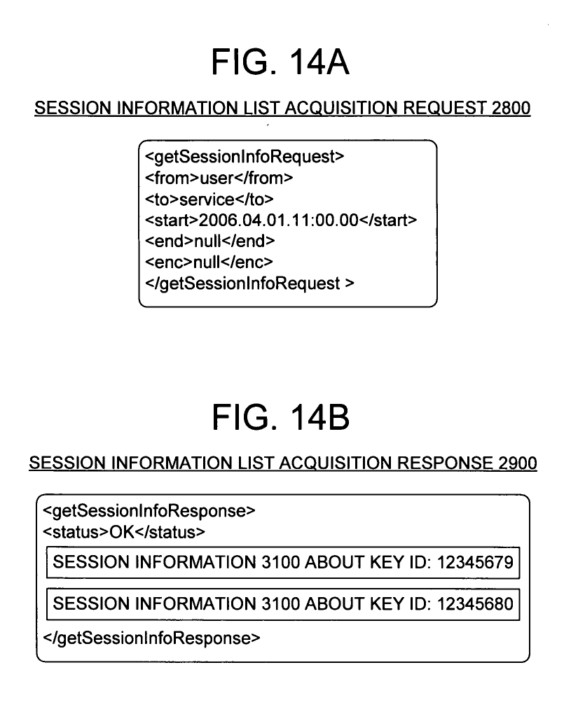

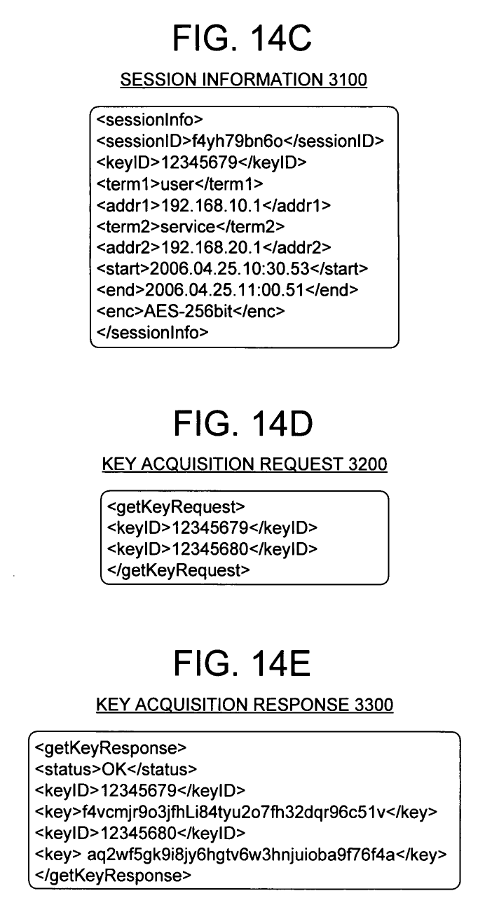

The session information list acquisition request 2800 in the first embodiment is written as a getSessionInfoRequest tag of an XML message. FIG. 14A shows only a part of the session information list acquisition request 2800 sent from the auditing device 600 to the session management device 100, that is necessary to explain this embodiment. Information entered as a search key in the session information search window 3400 is written in the session information list acquisition request 2800. Search key items entered in the “sender communication device name” field and the “receiver communication device name” field in the session information search window 3400 are written in a “from” tag and “to” tag of the session information list acquisition request 2800, respectively.

Also, a search key item entered in the “time slot for communication time” field is written in a start tag and end tag of the session information list acquisition request 2800. An encrypting algorithm name specified in the session information search window 3400 is written in an enc tag of the session information list acquisition request 2800. When nothing is entered in a search key field in the session information search window 3400, “null” is written in the corresponding tag of the session information list acquisition request 2800.

The session information notifying function 106 of the session management device 100 receives the session information list acquisition request 2800 from the auditing device 600 (Step S152). The communication management function 103 searches the communication state management DB 101 for session information of a communication session to be audited using the name of the user terminal 300 written in the “from” tag of the session information list acquisition request 2800, the name of the service providing server 350 written in the “to” tag, a time written in the start tag, a time written in the end tag, and an encrypting algorithm name written in the enc tag (Step S153).

Information stored in the communication state management DB 101 at this point is, for example, as shown in FIG. 11D. The communication management function 103 therefore obtains information held in the second record and the third record in the example of FIG. 11D. From each of the two sets of information obtained by the communication management function 103, the session information notifying function 106 creates session information 3100. The session information notifying function 106 in the first embodiment creates a session information list acquisition response 2900 containing the session information 3100 that holds a key ID “12345679” and the session information 3100 that holds a key ID “12345680”, and sends the created response to the auditing device 600 (Step S154).

The session information list acquisition response 2900 in the first embodiment is written as, for example, a getSessionInfoResponse tag of an XML message. FIG. 14B shows only a part of the session information list acquisition response 2900 sent from the session management device 100 to the auditing device 600, that is necessary to explain this embodiment. The result of the search for session information by the session management device 100 is written in a status tag of the session information list acquisition response 2900.

When session information of a communication session that meets conditions written in the session information list acquisition request 2800 is found as a result of the search, the session information notifying function 106 writes “OK” in the status tag, and writes “NG” when the search fails. The created session information 3100 is written in, for example, the XML format. In the case where multiple keys are used in one session, the session information list acquisition response 2900 may contain multiple pieces of session information 3100.

The session information 3100 is expressed as, for example, a sessioninfo tag in the XML format. The session information 3100 contains, for example, as shown in FIG. 14C, a sessionID tag in which a session ID obtained from the communication state management DB 101 is written, a keyID tag in which a key ID is written, a term1 tag in which a sender communication device name stored in the memory 12 of the session management device 100 is written, an addr1 tag in which the IP address of the sender communication device is written, a term2 tag in which the name of a communication device on the other end of the communication session is written, an addr2 tag in which the IP address of the communication device on the other end of the communication session is written, a start tag in which a communication start time is written, an end tag in which a communication end time is written, and an enc tag in which the name of an encrypting algorithm employed is written.

The session information acquisition function 602 of the auditing device 600 receives the session information list acquisition response 2900 from the session management device 100 (Step S155), and the auditing application 604 shifts the internal state of the auditing device 600 to “pre-audit”. In cases where “NG” is written in the status tag of the session information list acquisition response 2900, the auditing application 604 prompts the auditor to conduct again a search for session information of the communication session to be audited, and displays the session information search window 3400 once more. The auditor re-enters a search key on the session information search window 3400, and the auditing application 604 executes Step S150 again.

In the case where “OK” is written in the status tag of the session information list acquisition response 2900, the auditing application 604 displays in a session information search result window 3500 a result of checking the obtained session information 3100 against a search key stored in the memory 12 of the auditing device 600.

The auditing application 604 in the first embodiment displays the session information search result window 3500 as shown in FIG. 16B. Displayed in the session information search result window 3500 along with a newly assigned audit ID are a session ID written in the sessionID tag of the session information 3100, a sender communication device name written in the term1 tag, a sender communication device IP address written in the addr1 tag, a receiver communication device name written in the term2 tag, a receiver communication device IP address written in the addr2 tag, a communication start time written in the start tag, a communication end time written in the end tag, and an encrypting algorithm name written in the enc tag.

In a case of displaying the session information search result window 3500, when a sender communication device name entered as a search key matches a name written in the term1 tag, the auditing application 604 writes information that is held in the term1 tag and the addr1 tag in a field for the name of the sender communication device in the displayed session information search result window 3500. Similarly, when a receiver communication device name entered as a search key matches a name written in the term2 tag, the auditing application 604 writes information that is held in the term2 tag and the addr2 tag in a field for the name of the receiver communication device in the displayed session information search result window 3500.

In cases where two or more of multiple pieces of session information 3100, obtained from the session information list acquisition response 2900, hold the same session ID in their session ID tags, the auditing application 604 compiles the two or more pieces of session information 3100 and displays as session information of one communication session in the session information search result window 3500.

The auditor looks at the session information search result window 3500 to check session information of an encrypted communication session to be audited. To reset conditions of search for a communication session to be audited, the auditor presses a “search again” button displayed in the session information search result window 3500. Pressing of the “search again” button causes the auditing application 604 to display the session information search window 3400 again and execute Step S150 once more using a search key entered by the auditor. The auditor can thus perform audit processing more efficiently by consulting the session information search result window 3500.

When the auditor decides to carry out auditing of communications that are associated with session information found as a result of the search instead of redoing the search, the auditor chooses a communication session to be audited from the communication session information list displayed in the session information search result window 3500, and presses a “start audit” button. Pressing of the “start audit” button causes the auditing application 604 to store in the memory 12 of the auditing device 600 the information of the communication session chosen as an audit subject, and causes the key acquisition function 601 to create a key acquisition request 3200 and to send the request to the key management device 200 (Step S156).

The key acquisition request 3200 in the first embodiment is written as, for example, a getKeyRequest tag of an XML message as shown in FIG. 14D. FIG. 14D shows only a part of the session information 3100 sent from the auditing device 600 to the key management device 200, that is necessary to explain this embodiment. A key ID used in a communication session to be audited is written in a keyID tag of the key acquisition request 3200. Multiple keyID tags may be contained in one key acquisition request 3200.

The key sending/receiving function 203 of the key management device 200 receives the key acquisition request 3200 from the auditing device 600 (Step S157), and the key management function 202 searches the key management DB 201 using as a key, a key ID that is written in the keyID tag of the key acquisition request 3200 (Step S158). It is assumed that information stored in the key management DB 201 at this point is, for example, as shown in FIG. 13D.

The key management function 202 detects that the key ID written in the keyID tag of the key acquisition request 3200 is registered in the second record and the third record in the key management DB 201. The key management function 202 obtains a key from the second record and a key from the third record (Step S159). The key sending/receiving function 203 uses the obtained keys to create a key acquisition response 3300, and sends the created response to the auditing device 600 (Step S160).

The key acquisition request 3300 in the first embodiment is written as, for example, a getKeyResponse tag of an XML message as shown in FIG. 14E. FIG. 14E shows only a part of the key acquisition response 3300 sent from the key management device 200 to the auditing device 600, that is necessary to explain this embodiment. The key sending/receiving function 203 writes, in a status tag of the key acquisition response 3300, the result of obtaining a key ID and a key that are used in a communication session to be audited from the key management DB 201. When the key ID and the key are successfully obtained, “OK” is written in the status tag and “NG” is written in the status tag when the attempt to obtain is a failure. The key ID used in the communication session to be audited is written in a keyID tag of the key acquisition response 3300, and the key is written in a key tag of the key acquisition response 3300. The key acquisition response 3300 may contain as many keyID tags and key tags as the number of communication sessions to be audited.

The key acquisition function 601 of the auditing device 600 receives the key acquisition response 3300 from the key management device 200 (Step S161), extracts from the key acquisition response 3300 a key ID written in the keyID tag and a key written in the key tag (Step S162), and saves the extracted key ID and key in the memory 12 of the auditing device 600. The packet acquisition/decrypting function 603 creates a packet acquisition request 3600 and sends the created request to the packet monitoring device 500 (Step S163).

The packet acquisition request 3600 in the first embodiment is written as, for example, a getPacketRequest tag of an XML message as shown in FIG. 15B. FIG. 15B shows only a part of the packet acquisition request 3600 sent from the auditing device 600 to the packet monitoring device 500, that is necessary to explain this embodiment. From audit subject communication session information stored in the memory 12 of the auditing device 600, the IP address of the sender communication device is written in a “from” tag of the packet acquisition request 3600, the IP address of the receiver communication device is written in a “to” tag, the start time is written in a start tag, and the end time is written in an end tag. The packet acquisition request 3600 may contain multiple sets of these tags for each session ID of a communication session to be audited.

The packet sending function 504 of the packet monitoring device 500 receives the packet acquisition request 3600 from the auditing device 600 (Step S164). The packet management function 503 extracts from the packet acquisition request 3600 the IP address of the user terminal 300 written in an addr1 tag, the IP address of the service providing server 350 written in an addr2 tag, an encrypted communication start time written in the start tag, and an encrypted communication end time written in the end tag, and searches the packet DB 501 using the extracted information as a key. It is assumed that information stored in the packet DB 501 at this point is, for example, as shown in FIG. 15A.

The packet management function 503 detects that the first record in the packet DB 501 holds the IP address of the user terminal 300 which is written in the addr1 tag of the packet acquisition request 3600 and the IP address of the service providing server 350 which is written in the addr2 tag. The packet management function 503 then confirms that a date contained in the term from the start time written in the start tag of the of the packet acquisition request 3600 to the end time written in the end tag matches the last eight digits of a name registered in the packet storing location cell of the first record. In other words, in FIG. 15B, “Apr. 1, 2006” is the date at which the encrypted communication session, whose packet is requested to be obtained, is performed, and the packet management function 503 confirms that the last eight digits of a packet storing location written in the first record in FIG. 15A are “20060401”. The packet management function 503 then accesses the storage place indicated by the packet storing location cell of the first record, and obtains the encrypted packet that has been sent from the user terminal 300 to the service providing server 350 during the communication session to be audited (Step S165).

The packet sending function 504 creates a packet acquisition response 3700 and sends the created response to the auditing device 600 (Step S166). The packet acquisition/decrypting function 603 of the auditing device 600 receives the packet acquisition request 3700 from the packet monitoring device 500 (Step S167), and the auditing application 604 displays a window to the effect that the encrypted packet has been obtained by the packet monitoring device 500. The auditor learns of the successful acquisition of the encrypted packet by looking at the window displayed by the auditing application 604.

The packet acquisition response 3700 in the first embodiment is written as, for example, a getPacketResponse tag of an XML message as shown in FIG. 15C. FIG. 15C shows only a part of the packet acquisition response 3700 sent from the packet monitoring device 500 to the auditing device 600, that is necessary to explain this embodiment. The result of obtaining the encrypted packet from the packet DB 501 is written in a status tag of the packet acquisition response 3700. When the encrypted packet is successfully obtained, “OK” is written in the status tag, and “NG” is written in the status tag when the attempt is a failure.

Thereafter, the packet sending function 504 of the packet monitoring device 500 sends, to the auditing device 600, the encrypted packet that has been sent from the user terminal 300 to the service providing server 350 (Step S168). The packet acquisition/decrypting function 603 of the auditing device 600 receives the encrypted packet from the packet monitoring device 500 (Step S169), and stores the encrypted packet in the external storage 17 in the auditing device 600.

When there is no encrypted packet left to be sent to the auditing device 600, the packet sending function 504 of the packet monitoring device 500 creates a packet transmission completion notification 3800 and sends the notification to the auditing device 600 (Step S170). The packet transmission completion notification 3800 in the first embodiment is written as, for example, an endSendingPacketInfo tag of an XML message as shown in FIG. 15D.

The packet acquisition/decrypting function 603 of the auditing device 600 receives the packet transmission completion notification 3800 from the packet monitoring device 500 (Step S171), and the auditing application 604 shifts the internal state of the auditing device 600 to “executing audit processing”. The packet acquisition/decrypting function 603 takes a key and audit subject communication session information out of the memory 12 of the auditing device 600, and decrypts the encrypted packet stored in the external storage 17 of the auditing device 600. Based on the decrypted packet, the auditor audits communications exchanged in the communication session between the user terminal 300 and the service providing server 350.

After completing the audit, the auditor instructs the auditing application 604 to end the audit processing. The auditing application 604 deletes the stored key ID and key from the memory 12 of the auditing device 600, and deletes the stored encrypted packet from the external storage 17 of the auditing device 600. The auditing application 604 then ends the audit processing (Step S172), shifts the internal state of the auditing device 600 to “standby”, and displays a message informing the end of the audit processing. The auditor recognizes the fact that the auditing processing has been ended by looking at the message displayed by the auditing application 604.

Described above is the operation sequence in which, after an encrypted communication session is ended, the auditing device 600 obtains an encrypted packet stored in the packet DB 501, decrypts an obtained encrypted packet, and audits the contents of the packet. In auditing communications, the auditing application 604 may display a summary of a communication session which includes the type of an application protocol used in the communication session (HTTP or the like) and the name (URL or the like) of a resource of the service providing server 350 that has been accessed by the user terminal 300 during the communication session by analyzing a series of decrypted packets.

According to the first embodiment, auditing of communications exchanged in an encrypted communication session can be conducted not only after the encrypted communication session is ended but also in real time while the encrypted communication session is being performed. In real-time auditing, after Steps S150 to S155 of FIG. 8 are executed, the session information search result window 3500 displayed by the auditing application 604 of the auditing device 600 contains session information of an encrypted communication session that is currently being performed. When the auditor chooses the current encrypted communication session in the session information search result window 3500, Steps S156 to S171 are executed, and then the auditing application 604 of the auditing device 600 performs real-time audit processing and ends the audit processing in Step S172.

Also, in the first embodiment, key information may be created not by the key management device 200 but by the user terminal 300, the service providing server 350, or other communication devices that hold an encrypted communication session. The user terminal 300 and the service providing server 350 in this case are equipped with an additional function of generating a key. The operation sequence at the start of an encrypted communication session and upon key update in this case is as follows.

First, in Step S101, the key generating function of the user terminal 300 creates the key information 3000 containing a key with which a packet to be sent to the service providing server 350 is encrypted, the validity period of the key, and the name of an encrypting algorithm, stores the created information 3000 in the memory 12 of the user terminal 300, and writes the created key information 3000 in the BODY section of the communication start request 2000. The SIP client function 302 of the user terminal 300 sends the communication start request 2000 to the session management device 100.

The message sending/receiving function 105 of the session management device 100 receives the communication start request 2000 from the user terminal 300 in Step S102, and the key acquisition function 104 stores in the memory 12 of the session management device 100 the key information 3000 written in the BODY section of the communication start request 2000. The message sending/receiving function 105 then executes Step S110, where the message sending/receiving function 105 sends the communication start request 2000 to the service providing server 350.

Next, the service providing server 350 executes Steps S111 to S115. In Step S113, the key acquisition function 301 of the service providing server 350 obtains the key information 3000 written in the BODY section of the communication start request 2000, and stores the obtained key information 3000 in the memory 12 of the service providing server 350 in association with a session ID written in the Call-ID field of the communication start request 2000. The key stored here as a part of the key information 3000 is used in decrypting an encrypted packet that is sent from the user terminal 300, and is not used in encrypting a packet to be sent to the user terminal 300.

In Step S114, the key acquisition function 301 of the service providing server 350 writes the key information 3000 containing a key with which a packet to be sent to the user terminal 300 is encrypted, the validity period of the key, and the name of an encrypting algorithm in the BODY section of the communication start response 2100. The SIP client function 302 of the service providing server 350 sends the communication start response 2100 to the session management device 100.

The message sending/receiving function 105 of the session management device 100 receives the communication start response 2100 from the service providing server 350 in Step S116, and executes Step S117. When the communication start response 2100 contains a message of refusal of communication, the message sending/receiving function 105 executes Step S122 and subsequent steps. When the communication start response 2100 contains a message permitting communication, the message sending/receiving function 105 stores the key information 3000 contained within the communication start response 2100 in the memory 12 of the session management device 100. The key acquisition function 104 then executes Step S103, where the key acquisition function 104 creates the key generation request 2200 and sends the created request to the key management device 200. Written in the key generation request 2200 in this case are the key information 3000 that has been sent from the user terminal 300 and the key information 3000 that has been sent from the service providing server 350.

The key management device 200 executes Steps S104 to S107. In Step S105, the key management function 202 creates a key ID associated with the key information 3000 that has been sent from the user terminal 300 and written in the key generation request 2200, and a key ID associated with the key information 3000 that has been sent from the service providing server 350 and written in the key generation request 2200. In Step S106, the key management function 202 registers each of the created key IDs in the key management DB 201 along with an encrypting algorithm and a key that are contained in the key information 3000 associated with the key ID.

The key acquisition function 104 of the session management device 100 receives the key generation response 2300 from the key management device 200 in Step S108, and executes Steps S118 to S121. The key acquisition function 104 then writes the key information 3000 that has been sent from the service providing server 350 in the BODY section of the communication start response 2100, and executes Step S127.

The user terminal 300 then executes Steps S128 to S130. In Step S130, the key acquisition function 301 of the user terminal 300 obtains the key information 3000 written in the BODY section of the communication start response 2100, and stores the obtained key information 3000 in the memory 12 of the user terminal 300 in association with a session ID written in the Call-ID field of the communication start response 2100. The key stored here as a part of the key information 3000 is used in decrypting an encrypted packet sent from the service providing server 350, and is not used in encrypting a packet to be sent to the service providing server 350.

The operation sequence at the end of an encrypted communication session in this case differs from FIG. 6 in that, in Steps S135 and S140, the key acquisition functions 301 of the user terminal 300 and of the service providing server 350 delete the stored session ID and key information 3000 from their respective memories 12.

In the description given above on a case of generating a key used for encrypted communication in the user terminal 300 or the service providing server 350, different keys are used for transmission and reception. Alternatively, the same key may be used for transmission and reception. This eliminates the need for processing in which the service providing server 350 creates and sends the key information 3000 to the user terminal 300 and processing in which the key management device 200 registers the key information 3000 created by the service providing server 350 in the key management DB 201.

### Second Embodiment

In a second embodiment of the present invention, only encrypted communication sessions that are specified by the auditing device 600 are counted as audit subjects, and the packet monitoring device 500 does not obtain encrypted packets other than those sent in the encrypted communication sessions to be audited. This reduces the data amount of encrypted packets to be stored in the packet monitoring device 500.

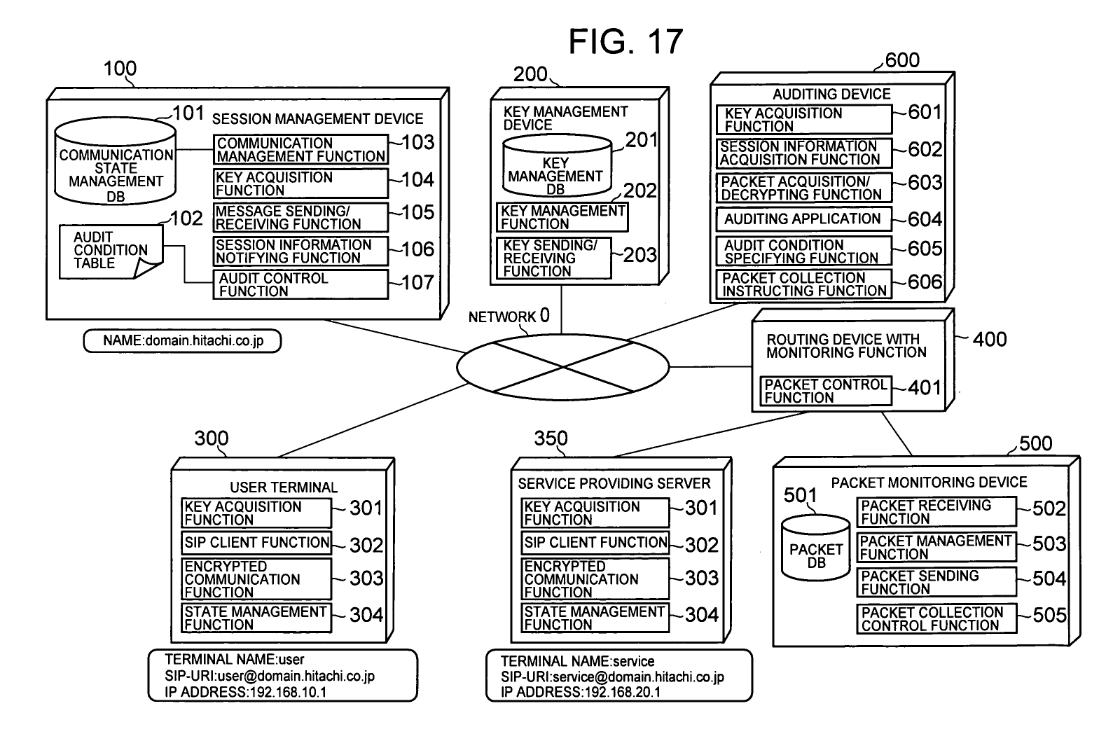

FIG. 17 is a system configuration diagram of a communications audit support system according to the second embodiment. The second embodiment differs from the first embodiment in that new functions are added to the session management device 100, the packet monitoring device 500, and the auditing device 600.

The session management device 100 is additionally equipped with an audit condition table 102, in which an audit condition specified by the auditing device 600 is registered, and a audit control function 107, which controls processing and components that are related to auditing of communications based on audit communications registered in the audit condition table 102. The session information notifying function 106 in the second embodiment has, in addition to the functions described in the first embodiment, a function of sending session information of an encrypted communication session to be audited to the auditing device 600 when the encrypted communication session is started.

The packet monitoring device 500 is additionally equipped with a packet collection control function 505, with which only encrypted packets sent in encrypted communication sessions that are specified by the auditing device 600 are obtained and other encrypted packets are discarded.

The auditing device 600 is additionally equipped with an audit condition specifying function 605, which is used to specify a condition of audit subject encrypted communication sessions to the session management device 100, and a packet collection instructing function 606, which is used to instruct the packet monitoring device 500 to collect encrypted packets sent in the encrypted communication session when a notification of the start of the encrypted communication session is received from the session management device 100. The auditing application 604 has, in addition to the functions described in the first embodiment, a function of setting a condition of audit subject encrypted communication sessions and auditing communications in an encrypted communication session that meets a specified audit condition in real time from the moment the encrypted communication session is started.

A description will be given next with reference to FIGS. 3, 4, 18, and 19 on the sequence of a series of operation steps in which the user terminal 300 shares, via the session management device 100, a key used in an encrypted communication session with the service providing server 350 and initiates the encrypted communication session. The second embodiment differs from the first embodiment in that the auditing device 600 specifies a condition of audit subject encrypted communication sessions and sets the condition in the session management device 100 in advance. Upon receiving a communication start request from the user terminal 300, the session management device 100 checks whether or not the encrypted communication session, that is about to start, meets the condition specified in advance by the auditing device 600 and, when the encrypted communication session meets the condition, notifies the auditing device 600 of the start of the encrypted communication session. The auditing device 600 then instructs the packet monitoring device 500 to collect packets.

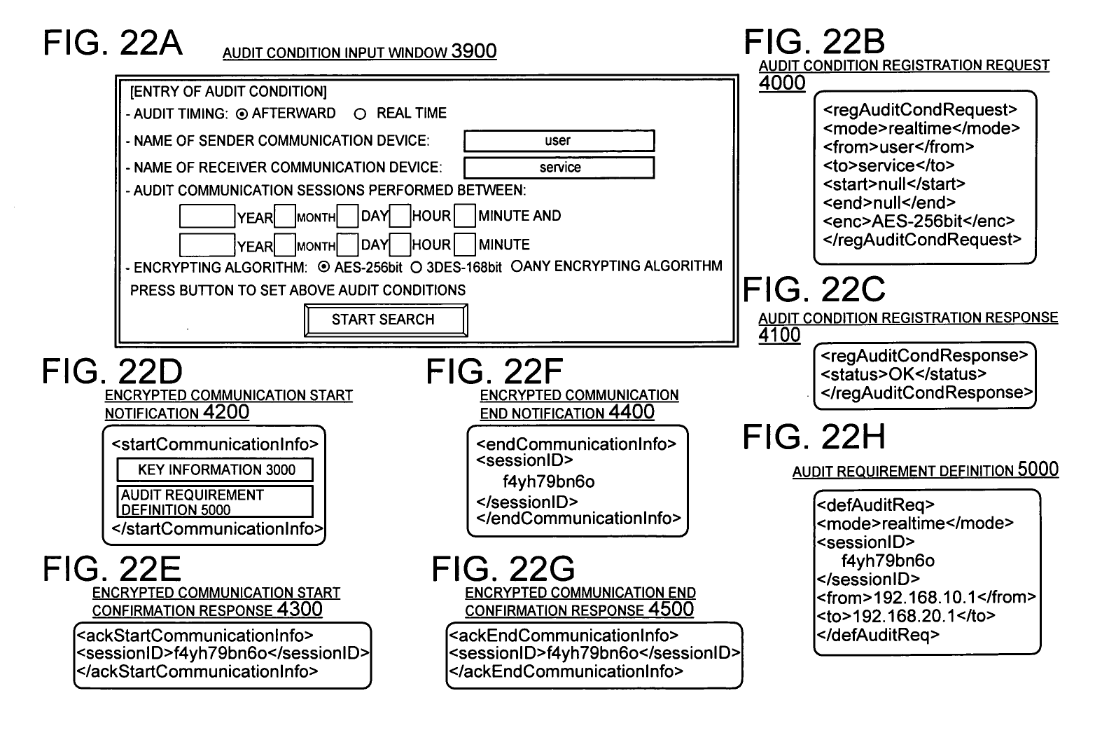

First, an auditor who operates the auditing device 600 enters a condition about audit subject encrypted communication sessions in an audit condition input window 3900 of FIG. 22a which is displayed by the auditing application 604. The auditing application 604 reads the audit condition entered (Step S201).

In the second embodiment, audit conditions entered in the audit condition input window 3900 include audit timing, the name of a sender communication device which initiates an encrypted communication session to be audited, the name of a receiver communication device, a time slot for the encrypted packet transmission time, and the name of an encrypting algorithm used in the encrypted communication session. In the example of the audit condition input window 3900 shown in FIG. 22A, audit conditions are set such that an encrypted packet that is sent from a communication device named “user” to a communication device named “service” and that has “AES-256 bit” as the name of an encrypting algorithm used in the communication session are indicated as the audit subject encrypted communication session. The fields in the audit condition input window 3900 for specifying the names of the communication devices and an audit target time slot may be blank. As to a search key field in which no entry is made, the auditing application 604 determines that the auditor has not specified any condition.

The audit condition specifying function 605 of the auditing device 600 creates an audit condition registration request 4000 from an audit condition entered in the audit condition input window 3900, and sends the created request to the session management device 100 (Step S202).

The audit condition registration request 4000 in the second embodiment is written as, for example, a regAuditCondRequest tag of an XML message as shown in FIG. 22B. FIG. 22B shows only a part of the audit condition registration request 4000 sent from the auditing device 600 to the session management device 100, that is necessary to explain this embodiment. Information entered as audit conditions in the audit condition input window 3900 is written in the audit condition registration request 4000. A condition chosen from “audit timing” options in the audit condition input window 3900 is written in a mode tag of the audit condition registration request 4000. Conditions entered in the “sender communication device name” field and the “receiver communication device name” field in the audit condition input window 3900 are written in a “from” tag and a “to” tag of the audit condition registration request 4000, respectively.

Conditions entered in the “audit target time slot” field in the audit condition input window 3900 are written in a start tag and an end tag of the audit condition registration request 4000. A condition chosen from “encrypting algorithm” options in the audit condition input window 3900 is written in an enc tag of the audit condition registration request 4000. When nothing is entered in an audit condition field in the audit condition input window 3900, “null” is written in the corresponding tag of the audit condition registration request 4000. When “after session” is chosen from the “audit timing” options in the audit condition input window 3900, “afterward” is written in the corresponding mode tag whereas “realtime” is written in the corresponding mode tag when “real time” is chosen.

The audit control function 107 of the session management device 100 receives the audit condition registration request 4000 from the auditing device 600 (Step S203), registers information of the audit condition registration request 4000 in the audit condition table 102 (Step S204), and creates and sends an audit condition registration response 4100 to the auditing device 600 (Step S205).

The audit condition registration response 4100 in the second embodiment is written as, for example, a regAuditCondResponse tag of an XML message as shown in FIG. 22C. FIG. 22C shows only a part of the audit condition registration response 4100 sent from the session management device 100 to the auditing device 600, that is necessary to explain this embodiment. The result of registration by the session management device 100 in the audit condition table 102 of the audit conditions written in the audit condition registration request 4000 is written in a status tag of the audit condition registration response 4100. When the audit conditions are registered in the audit condition table 102 normally, “OK” is written in the status tag and “NG” is written in the status tag when the session management device 100 fails in registering the audit conditions normally.

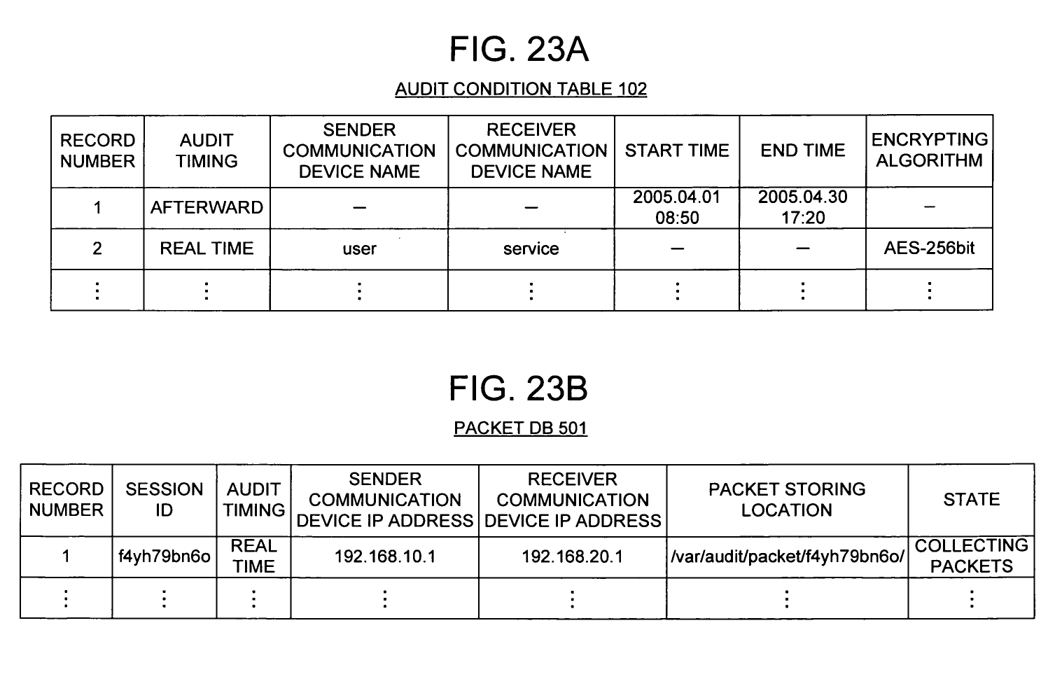

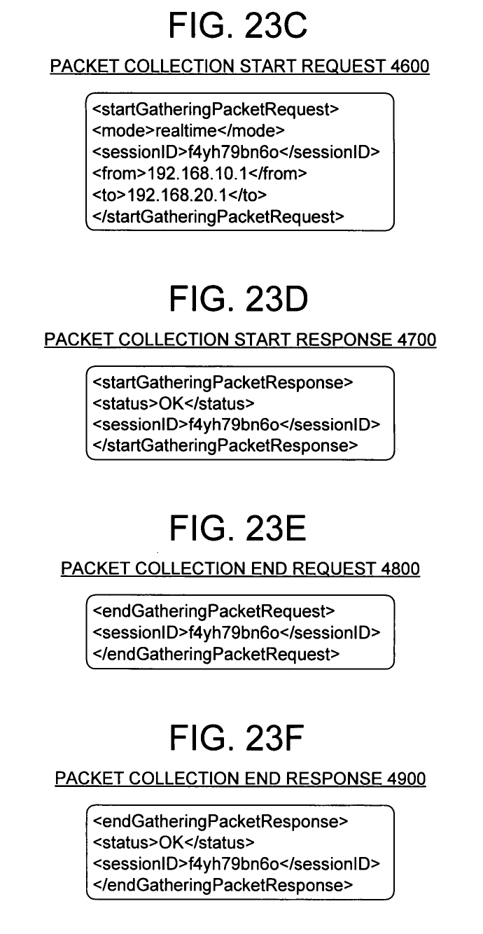

The audit condition table 102 of the session management device 100 stores, for example, as shown in FIG. 23A, audit timing, the name of a communication device that sends an encrypted packet, the name of a communication device that receives the encrypted packet, a time slot in which the encrypted communication session is performed, and the name of an encrypting algorithm used in the encrypted communication session. The example of FIG. 23A shows a state of the audit condition table 102 after audit conditions in the second row are added as a result of executing Step S204.

After the above series of processing steps is finished, in Step S102 described with reference to FIG. 3, the message sending/receiving function 105 of the session management device 100 receives the communication start request 2000 from the user terminal 300. The reception of the request is a trigger for sequential execution of Steps S103 to S121, which have been described with reference to FIG. 3 or 4. In other words, the session management device 100 obtains the key information 3000 created by the key management device 200 and sends the key information 3000 to the service providing server 350. The session management device 100 then updates the communication state management DB 101 upon reception of the communication start response 2100 from the service providing server 350. It is assumed that information held in the communication state management DB 101 after the update is, for example, as shown in FIG. 11B.

After the above processing is finished, the audit control function 107 of the session management device 100 judges whether or not the session information registered in the communication state management DB 101 in Step S121 matches the conditions registered in the audit condition table 102, to thereby judge whether or not the encrypted communication session that is about to start is an audit subject (Step S207). When it is found as a result that the encrypted communication session that is about to start is not an audit subject, the communications audit support system executes Step S127 and subsequent steps.

On the other hand, when it is found as a result of Step S207 that the encrypted communication session that is about to start is an audit subject, and when information held in the audit condition table 102 is as shown in FIG. 23A, the session information notifying function 106 of the session management device 100 creates an audit requirement definition 5000 from the conditions in the second row of the audit condition table 102 and from information registered in the second record of the communication state management DB 101 shown in FIG. 11B.

The audit requirement definition 5000 in the second embodiment is written as, for example, a defAuditReq tag of an XML format as shown in FIG. 22H. The audit requirement definition 5000 in the example of FIG. 22H contains a mode tag in which audit timing is written, a sessionID tag in which a session ID is written, a “from” tag in which the IP address of the sender communication device is written, and a “to” tag in which the IP address of the receiver communication device is written.

The session information notifying function 106 next creates an encrypted communication start notification 4200 in which the audit requirement definition 5000 is written (Step S208). The audit control function 107 refers to the mode tag of the audit requirement definition 5000 to judge whether an audit is to be conducted or not (Step S209).

When “afterward” is written in the mode tag of the audit requirement definition 5000, the session information notifying function 106 of the session management device 100 sends the encrypted communication start notification 4200 to the auditing device 600 (Step S211). When “realtime” is written in the mode tag of the audit requirement definition 5000, on the other hand, the session information notifying function 106 writes in the encrypted communication start notification 4200 the key information 3000 stored in the memory 12 of the session management device 100 (Step S210), and executes the same processing as Step S211.

The encrypted communication start notification 4200 in the second embodiment is written as, for example, a startCommunicationInfo tag of an XML message as shown in FIG. 22D. FIG. 22D shows only a part of the encrypted communication start notification 4200 sent from the session management device 100 to the auditing device 600 that is necessary to explain this embodiment. The audit requirement definition 5000 shown in FIG. 22H is written in the encrypted communication start notification 4200. In the case where an encrypted communication session is to be audited in real time, the key information 3000 described with reference to FIG. 12C is written in the encrypted communication start notification 4200 in addition to the audit requirement definition 5000.

The session information acquisition function 602 of the auditing device 600 receives the encrypted communication start notification 4200 from the session management device 100 (Step S212), stores the audit requirement definition 5000 written in the encrypted communication start notification 4200 in the memory 12 of the auditing device 600, and refers to the mode tag of the audit requirement definition 5000 to judge whether to conduct an audit (Step S213).

When “afterward” is written in the mode tag, the packet collection instructing function 606 of the auditing device 600 creates a packet collection start request 4600 and sends the created request to the packet monitoring device 500 (Step S215). When “realtime” is written in the mode tag, on the other hand, the session information acquisition function 602 of the auditing device 600 stores the key information 3000 written in the encrypted communication start notification 4200 in the memory 12 of the auditing device 600 in association with the audit requirement definition 5000 (Step S214). The auditing application 604 then shifts the internal state of the auditing device 600 to “real time audit”, and executes the same processing as Step S215.

The packet collection start request 4600 in the second embodiment is written as, for example, a startGatheringPacketRequest tag of an XML message as shown in FIG. 23C. FIG. 23C shows only a part of the packet collection start request 4600 sent from the auditing device 600 to the packet monitoring device 500, that is necessary to explain this embodiment. Information in the mode tag, sessionID tag, “from” tag, and “to” tag of the audit requirement definition 5000 is written in a mode tag, sessionID tag, “from” tag, and “to” tag of the packet collection start request 4600, respectively.

The packet collection control function 505 of the packet monitoring device 500 receives the packet collection start request 4600 from the auditing device 600 (Step S216), and writes information of the packet collection start request 4600 in a blank record of the packet DB 501. The packet management function 503 creates an area for storing the encrypted packet, and writes the storage place in the packet storing location cell of the record in the packet DB 501. The packet management function 503 then writes “collecting packets” in a state cell of the record in the packet DB 501. Thereafter, the packet collection control function 505 creates a packet collection start response 4700 and sends the created response to the auditing device 600 (Step S217), and shifts the internal state of the packet monitoring device 500 to “waiting for packet”.

The packet collection start response 4700 in the second embodiment is written as, for example, a startGatheringPacketResponse tag of an XML message as shown in FIG. 23D. FIG. 23D shows only a part of the packet collection start response 4700 sent from the packet monitoring device 500 to the auditing device 600 that is necessary to explain this embodiment. The result of registering in the packet DB 501 information of an encrypted communication session from which packets are collected is written in a status tag of the packet collection start response 4700. When the information is successfully registered, “OK” is written in the status tag and “NG” is written in the status tag when the registration fails. The packet collection start response 4700 also contains the sessionID tag of the packet collection start request 4600.

The packet DB 501 in the second embodiment has a data configuration as shown in FIG. 23B, and has a “session ID” field, an “audit timing” field, and a “state” field in addition to the fields of the packet DB 501 in the first embodiment which have been described with reference to FIG. 15A. This enables the packet monitoring device 500 to manage obtained encrypted packets by their session IDs, thus ensuring that an encrypted packet obtained for auditing is one that is associated with a session ID requested by the auditing device 600.

Also, by referring to the “audit timing” field during real-time auditing, the packet collection control function 505 can send a received encrypted packet immediately to the auditing device 600. Further, by checking the “state” field, the packet management function 503 of the packet monitoring device 500 can sort received packets by their session IDs in storing the received packets.

The packet collection instructing function 606 of the auditing device 600 receives the packet collection start response 4700 from the packet monitoring device 500 (Step S218). The session information acquisition function 602 creates an encrypted communication start confirmation response 4300 and sends the created response to the session management device 100 (Step S219). The encrypted communication start confirmation response 4300 in the second embodiment is written as, for example, an askStartCommunicationInfo tag of an XML message as shown in FIG. 22E. The sessionID tag of the audit requirement definition 5000 is written in the askStartCommunicationInfo tag.

The session information notifying function 106 of the session management device 100 receives the encrypted communication start confirmation response 4300 from the auditing device 600 (Step S220). The key acquisition function 104 writes the key information 3000, stored in the memory 12 of the session management device 100, in the BODY section of the communication start response 2100, which has been described with reference to FIG. 10B. The message sending/receiving function 105 then sends the communication start response 2100 to the user terminal 300, and executes Step S127 and subsequent steps which have been described in the first embodiment.

Described above is the operation sequence in which the user terminal 300 shares, via the session management device 100, a key used in an encrypted communication session with the service providing server 350 and initiates the encrypted communication session in the second embodiment.

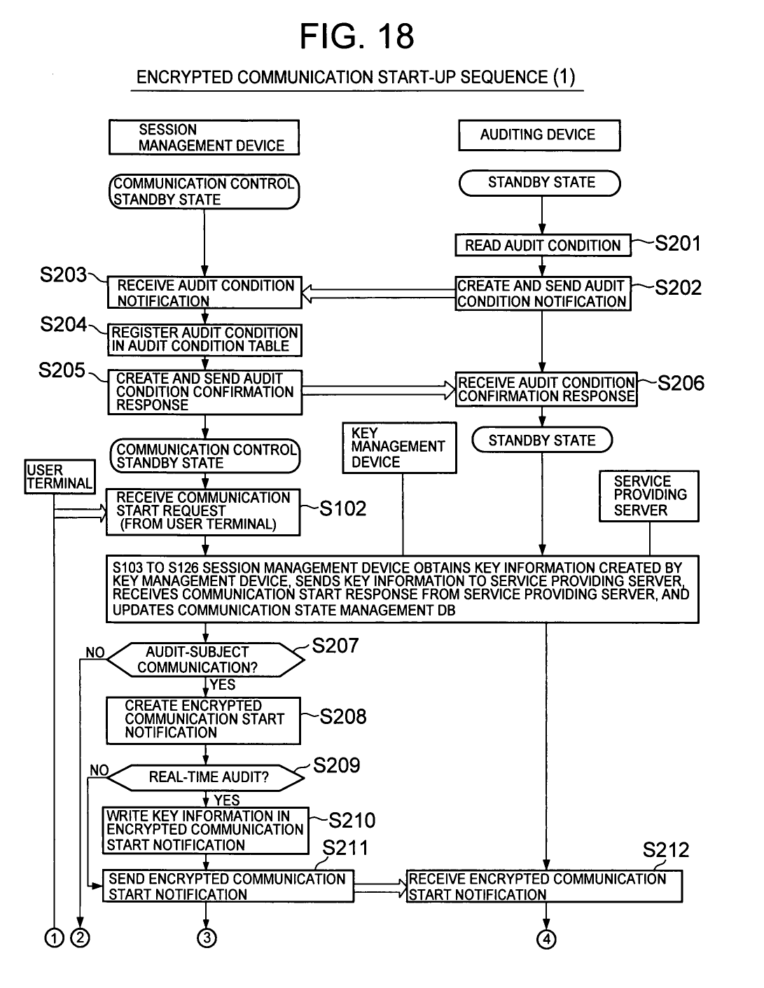

Steps S202 to S212 of FIG. 18 are common to the operation sequence for starting an encrypted communication session and a series of operation steps for updating a key shared between the user terminal 300 and the service providing server 350 upon expiration of the validity period of the key. When the auditing device 600 receives the encrypted communication start notification 4200 from the session management device 100 in Step S212, the internal state of the auditing device 600 is either “standby” or “real-time audit”. It is assumed that data in the communication state management DB 101 at this point is as shown in FIG. 11C.

The session information acquisition function 602 of the auditing device 600 receives the encrypted communication start notification 4200 from the session management device 100 in Step S212, and judges whether or not the memory 12 of the auditing device 600 holds the audit requirement definition 5000 that is associated with the encrypted communication start notification 4200. In the case where the associated audit requirement definition 5000 is found in the memory 12, the session information acquisition function 602 compares the sessionID tag of the audit requirement definition 5000 that is written in the encrypted communication start notification 4200 against the sessionID tag of the audit requirement definition 5000 that is kept in the memory 12 of the auditing device 600. When the session ID tags hold the same session ID, it is judged that the series of processing steps is triggered at key updating.

When the mode tag of the audit requirement definition 5000 reads “afterward” in Step S213, Step S219 is executed. When the mode tag of the audit requirement definition 5000 reads “realtime” in Step S213, on the other hand, Step S214 is executed and then Step S219 is executed.

Described above is the operation sequence for updating a key shared between the user terminal 300 and the service providing server 350 in the second embodiment upon expiration of the validity period of the key. In the key update sequence, the communication start request 2000 may be sent from the service providing server 350 to the user terminal 300 via the session management device 100. Also the series of operation steps for updating a key may be executed shortly before the validity period of the key instead of upon expiration of the validity period of the key.

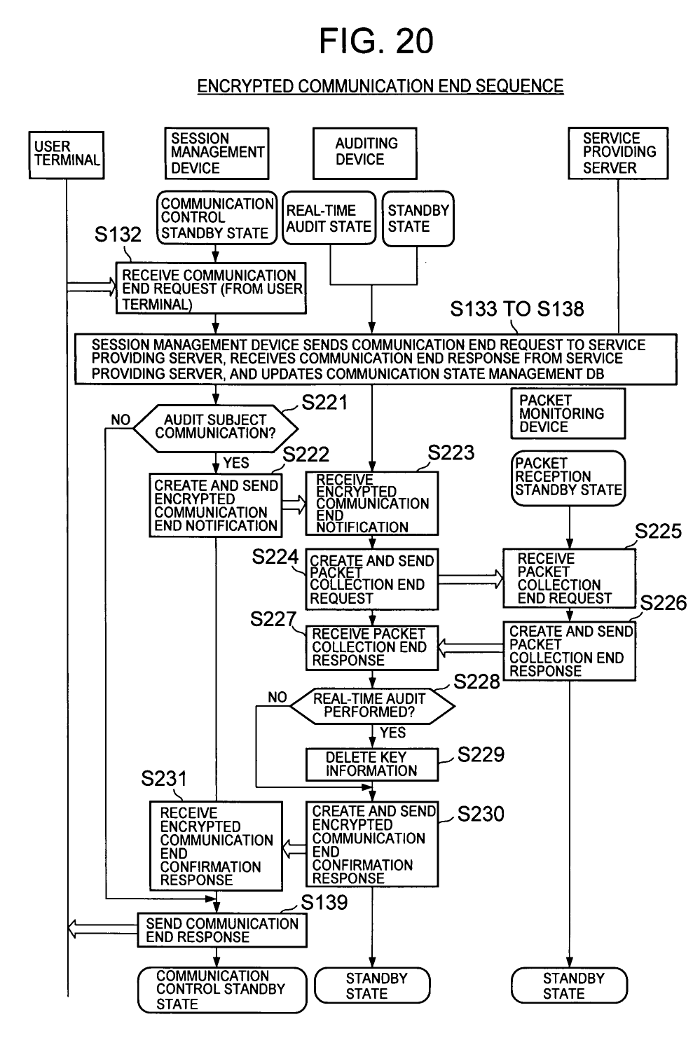

A description will be given next with reference to FIG. 20 on the sequence of a series of operation steps in which the user terminal 300 ends via the session management device 100 an encrypted communication session with the service providing server 350.

In Step S132, the message sending/receiving function 105 of the session management device 100 receives the communication end request 2400 from the user terminal 300, and Steps S133 to S138 described in the first embodiment with reference to FIG. 6 are executed sequentially. In other words, the session management device 100 sends the communication end request 2400 to the service providing server 350, receives the communication end response 2500 from the service providing server 350, and then updates information in the communication state management DB 101.

After the above processing is finished, the audit control function 107 of the session management device 100 judges whether or not information registered in the communication state management DB 101 in Step S121 meets conditions registered in the audit condition table 102, to thereby judge whether or not the encrypted communication session requested to be ended is an audit subject (Step S221).

When the encrypted communication session requested to be ended is not an audit subject (S221: No), the communications audit support system executes Step S139 and subsequent steps. When the encrypted communication session requested to be ended is an audit subject (S221: Yes), the session information notifying function 106 of the session management device 100 creates an encrypted communication end notification 4400 and sends the notification to the auditing device 600 (Step S222).

The encrypted communication end notification 4400 in the second embodiment is written as, for example, an endCommunicationInfo tag of an XML message as shown in FIG. 22F. FIG. 22F shows only a part of the encrypted communication end notification 4400 sent from the session management device 100 to the auditing device 600 that is necessary to explain this embodiment. A session ID written in the Call-ID field of the communication end request 2400 is written in a sessionID tag of the encrypted communication end notification 4400.

The session information acquisition function 602 of the auditing device 600 receives the encrypted communication end notification 4400 from the session management device 100 (Step S223), and creates a packet collection end request 4800 and sends the created request to the packet monitoring device 500 (Step S224).

The packet collection end request 4800 in the second embodiment is written as, for example, an endGatheringPacketRequuest tag of an XML message as shown in FIG. 23E. FIG. 23E shows only a part of the packet collection end request 4800 sent from the auditing device 600 to the packet monitoring device 500, that is necessary to explain this embodiment. The packet collection end request 4800 contains a sessionID tag in which information in the sessionID tag of the encrypted communication end notification 4400 is written.

The packet collection control function 505 of the packet monitoring device 500 receives the packet collection end request 4800 from the auditing device 600 (Step S225) and ends collecting of packets. Specifically, when data in the packet DB 501 is in a state as shown in FIG. 23B, the packet collection control function 505 rewrites information in the state cell of a record that has a session ID written in the packet collection end request 4800, to change the information from “collecting packets” to “finished collecting packets”. The packet collection control function 505 then creates and sends a packet collection end response 4900 to the auditing device 600 (Step S226), and shifts the internal state of the packet monitoring device 500 to “standby”.

The packet collection end response 4900 in the second embodiment is written as, for example, an endGatheringPacketResponse tag of an XML message as shown in FIG. 23F. FIG. 23F shows only a part of the packet collection end response 4900 sent from the packet monitoring device 500 to the auditing device 600, that is necessary to explain this embodiment. The result of packet collection ending processing executed by the packet collection control function 505 is written in a status tag of the packet collection end response 4900. When the ending processing succeeds, “OK” is written in the status tag and “NG” is written in the status tag when the ending processing fails. The sessionID tag of the packet collection end request 4800 is written in the packet collection end response 4900.

The packet collection instructing function 606 of the auditing device 600 receives the packet collection end response 4900 from the packet monitoring device 500 (Step S227), and the session information acquisition function 602 judges whether or not the encrypted communication session requested to be ended has been audited in real time (Step S228). In the case where “afterward” is stored in the memory 12 of the auditing device 600 together with the session information 3100 after Step S212 as information that indicates audit timing, the session information acquisition function 602 judges that the encrypted communication session has not been audited in real time, and creates and sends an encrypted communication end confirmation response 4500 to the session management device 100 (Step S230).

In the case where “realtime” has been stored as information indicating audit timing, on the other hand, the session information acquisition function 602 judges that the encrypted communication session has been audited in real time, deletes the key information 3000 stored in the memory 12 of the auditing device 600 (Step S229), shifts the internal state of the auditing device 600 to “standby”, and then executes Step S230. The encrypted communication end confirmation response 4500 in the second embodiment is described as, for example, an ackEndCommunicationInfo tag of an XML message as shown in FIG. 22G The sessionID tag of the encrypted communication end notification 4400 is written in the ackEndCommunicationInfo tag.

The session information notifying function 106 of the session management device 100 receives the encrypted communication end confirmation response 4500 from the auditing device 600 (Step S231). The message sending/receiving function 105 then creates and sends the communication end response 2500 to the user terminal 300, and executes Step S139 and subsequent steps which have been described in the first embodiment.

Described above is the operation sequence in which the user terminal 300 ends via the session management device 100 an encrypted communication session with the service providing server 350 in the second embodiment. In the communication ending sequence, as in the first embodiment, encrypted communication may be ended by sending the communication end request 2400 from the service providing server 350 to the user terminal 300 via the session management device 100.

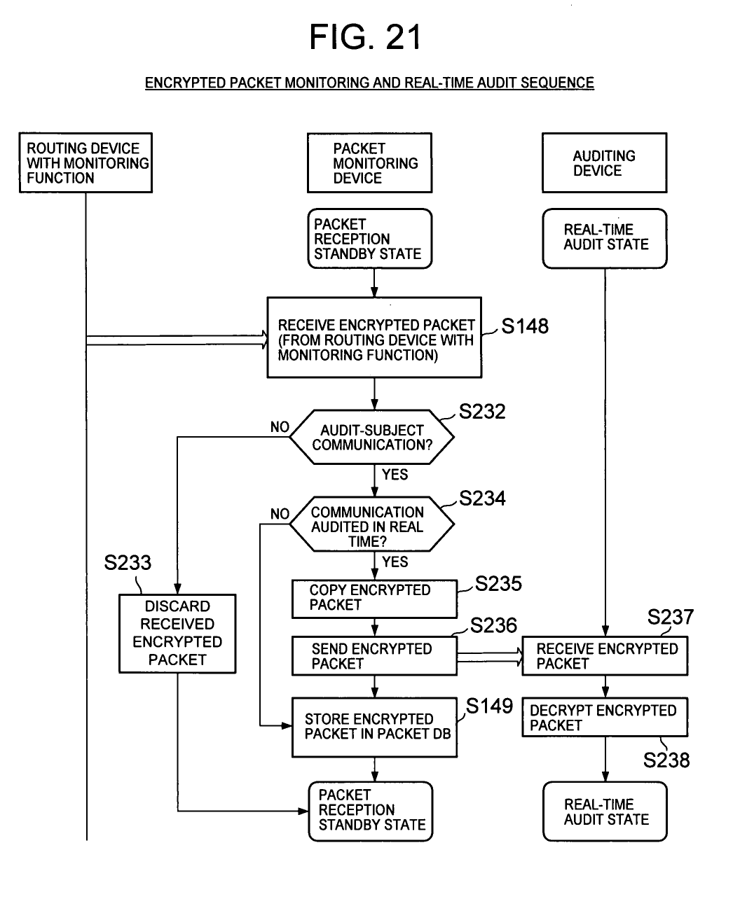

A description will be given next with reference to FIG. 21 on the sequence of a series of operation steps in which an encrypted packet is exchanged between the user terminal 300 and the service providing server 350. FIG. 21 takes as an example a case in which an encrypted packet is sent from the user terminal 300 to the service providing server 350. Every encrypted packet sent or received in an encrypted communication session between the user terminal 300 and the service providing server 350 necessarily passes through the routing device 400 with a monitoring function.

The packet receiving function 502 of the packet monitoring device 500 receives an encrypted packet from the routing device 400 with a monitoring function in Step S148, and the packet collection control function 505 judges whether or not the received encrypted packet is an audit subject (Step S232).

In cases where no record in the packet DB 501 holds a combination of a sender IP address and a receiver IP address that are written in the header of the received encrypted packet, or in cases where the packet DB 501 has a record that holds the IP address combination but “finished collecting packets” is written in the “state” cell of the record, the packet collection control function 505 judges that the received encrypted packet is not an audit subject (Step S232: No), and discards the received encrypted packet (Step S233).

When it is judged that the received encrypted packet is an audit subject (S232: Yes), on the other hand, the packet collection control function 505 refers to the “audit timing” field of the packet DB 501 to judge whether or not the audit of the received encrypted packet is real-time auditing (Step S234).

When “after session” (“afterward”) is written in the “audit timing” field (S234: No), the packet management function 503 stores the received encrypted packet in the packet DB 501 (Step S149). When “real time” is written in the “audit timing” field (S234: Yes), on the other hand, the packet collection control function 505 copies the received encrypted packet (Step S235), sends the copy of the encrypted packet to the auditing device 600 (Step S236), and executes Step S149.

The packet acquisition/decrypting function 603 of the auditing device 600 receives the encrypted packet from the packet monitoring device 500 (Step S237), and refers to a sender device IP address and a receiver device IP address that are written in the header area (see FIG. 15E) of the encrypted packet to obtain the audit requirement definition 5000 and the key information 3000 that have the IP address combination from the memory 12 of the auditing device 600. The packet acquisition/decrypting function 603 decrypts the encrypted packet with the obtained key information 3000 (Step S238). Based on the decrypted packet, the auditor audits communications exchanged in the communication session between the user terminal 300 and the service providing server 350.

Described above is the operation sequence in which, after an encrypted communication is started, an encrypted packet is exchanged between the user terminal 300 and the service providing server 350 in the second embodiment. In the sequence, as in the first embodiment, an encrypted packet may be sent from the service providing server 350 to the user terminal 300.

In the first embodiment and second embodiment described above, communication between the user terminal 300 and the session management device 100 and communication between the service providing server 350 and the session management device 100 may employ a public key or public key certificate. In this case, public keys or public key certificates on which the public keys are written, of the user terminal 300 and the service providing server 350, are kept in the session management device 100, and a public key or a public key certificate on which the public key is written, of the session management device 100, is kept in the user terminal 300 and the service providing server 350. SIP messages can be sent after encrypted by the public key of the party on the other end of the communication session, and SIP messages may be decrypted after reception with a private key of the own device. The risk of leakage of the key information 3000 is thus reduced.

A communications audit support system of the embodiments may have multiple devices each of which stores the communication state management DB 101, the key management DB 201, and the packet DB 501, so that session information-related data, data about a key, a key ID, and an encrypting algorithm name, and encrypted packets are managed in a distributed manner. This makes it possible to avoid the risk of complete loss of data caused by a failure in a single database.

When multiple devices each store data in the key management DB 201 in a distributed manner, a key may be split into pieces of information by secret sharing. This reduces the risk of key leakage even more.

The communications audit support system of the second embodiment may have multiple packet monitoring devices 500 and routing devices 400 with a monitoring function. The auditing device 600 in this case stores a table that holds information indicating the addresses of the packet monitoring devices 500 connected to the respective routing devices 400 with a monitoring function. Information indicating the addresses of the packet monitoring devices 500 is, for example, subnet mask plus IP address. The auditing device 600 refers to the table to give an instruction to every relevant packet monitoring device 500.

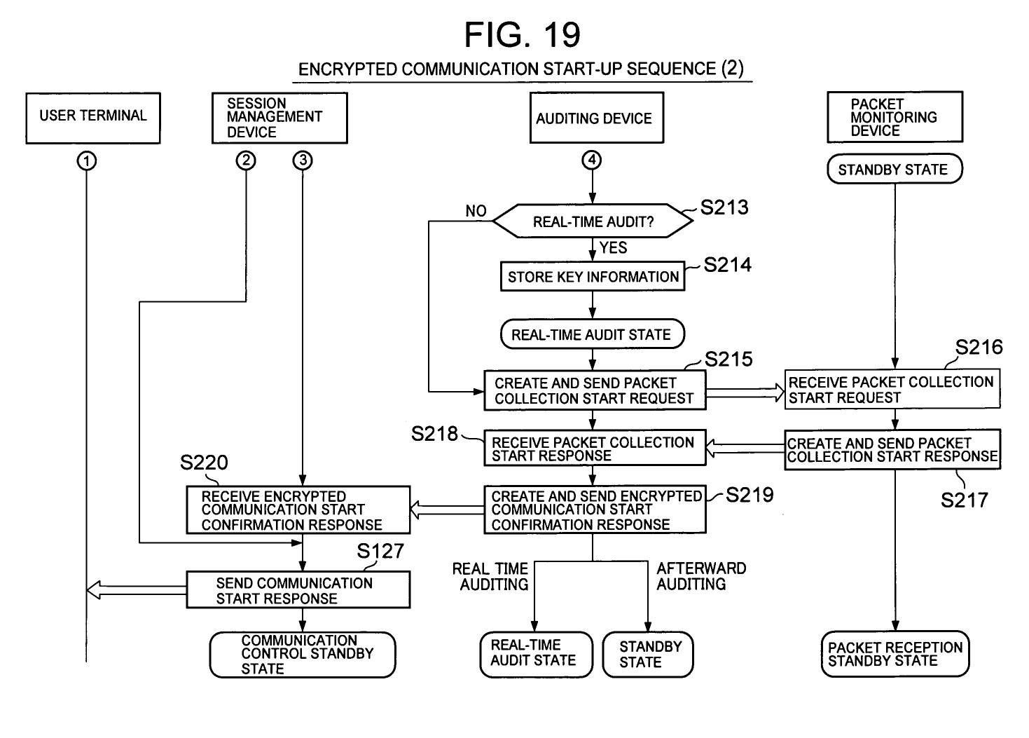

Specifically, in Step S215 of FIG. 19, the packet collection instructing function 606 of the auditing device 600 refers to the table that holds information indicating the addresses of the packet monitoring devices 500 to judge which packet monitoring device 500 is to receive a packet collection instruction. In the judging process, the packet collection instructing function 606 uses a sender IP address and a receiver IP address written in the audit requirement definition 5000 stored in the memory 12 of the auditing device 600, and checks the packet monitoring device 500 that is in the same network as one of the sender and receiver communication devices.

In the example of FIG. 22H where the user terminal 300 and the service providing server 350 which hold an encrypted communication session have an IP address “192.168.10.1” and an IP address “192.168.20.1”, respectively, the packet monitoring device 500 whose IP address is “192.168.20.10” and subnet mask is “255.255.255.0” belongs to the same network as the service providing server 350. Through the judging method, the auditing device 600 sends the packet collection start request 4600 to the packet monitoring device 500 whose IP address is “192.168.20.10” and subnet mask is “255.255.255.0”.

In the second embodiment, as in the first embodiment, key information may be created by the user terminal 300 and the service providing server 350 instead of the key management device 200. The operation sequence in this case uses, instead of the key information 3000 that is created by the key management device 200, a combination of the key information 3000 that is created by the user terminal 300 and a key ID, and a combination of the key information 3000 that is created by the service providing server 350 and a key ID. The rest is the same as the operation sequence described supplementally in the first embodiment.

The above description of the present invention has been presented through embodiments, but the technical scope of the present invention is not limited to that described in the above embodiments. It is obvious to those skilled in the art that various modifications and improvements can be made to the above embodiments. The following scope of claims clearly shows that such modified or improved modes can also be included in the technical scope of the present invention.

The specification and drawings are, accordingly, to be regarded in an illustrative rather than a restrictive sense. It will, however, be evident that various modifications and changes may be made thereto without departing from the spirit and scope of the invention as set forth in the claims.

What is claimed is:

1. A communications audit support system which provides information necessary to audit encrypted communication performed between multiple communication devices, the system comprising:
a key management unit which, each time key information used for encrypted communication is created, stores the created key information in a key management database (DB) in association with a key ID with which the key information is identified;
a communication management unit which, each time an encrypted communication session is established, stores IP addresses of multiple communication devices that perform the encrypted communication session, in a communication state management DB in association with a key ID of key information used in the encrypted communication session;
a packet acquisition unit which obtains a copy of an encrypted packet sent in encrypted communication, and stores the obtained copy of the encrypted packet in a packet DB in association with IP addresses of a sender and a receiver of the encrypted packet; and
a communication information output unit which refers to the communication state management DB upon reception of a search instruction from a user, identifies a key ID associated with an IP address of a communication device that has performed an encrypted communication session identified by the search instruction, extracts, from the key management DB, key information that is associated with the identified key ID, extracts, from the packet DB, a copy of an encrypted packet that is identified by the search instruction, and outputs the extracted key information and copy of the encrypted packet.

2. A communications audit support system according to claim 1, wherein
the communication management unit further stores information indicating a time slot in which an encrypted communication session has been performed, in the communication state management DB in association with a key ID of key information used in the encrypted communication session;
the packet acquisition unit further stores a time at which a copy of an encrypted packet is obtained, in the packet DB in association with IP addresses of a sender and a receiver of the encrypted packet; and
the search instruction contains one of: an IP address of a sender of an encrypted packet, an IP address of a receiver of an encrypted packet, a time slot in which a copy of the encrypted packet is obtained, and a combination thereof.

3. A communications audit support system according to claim 1, further comprising an audit condition storing unit which stores an audit condition set in advance in order to identify an audit subject encrypted communication session, wherein the packet acquisition unit
stores the obtained copy of the encrypted packet in the packet DB when the copy of the encrypted packet meets the audit condition, and
discards the encrypted packet when the obtained copy of the encrypted packet does not meet the audit condition.

4. A communications audit support system according to claim 3, further comprising a key information notification unit which, when the audit condition includes indicating immediate execution of auditing, and an encrypted communication session that meets the audit condition is established, obtains key information used in the encrypted communication session from the key management DB, and sends the obtained key information to the communication information output unit, wherein
when the audit condition includes indicating immediate execution of auditing, the packet acquisition unit further sends a copy of an encrypted packet that meets the audit condition, to the communication information output unit; and
the communication information output unit outputs the key information sent from the key information notification unit and the copy of the encrypted packet received from the packet acquisition unit.

5. A communications audit support system according to claim 3, wherein the audit condition contains one of: an IP address of a sender of an encrypted packet; an IP address of a receiver of an encrypted packet; a time slot in which a copy of the encrypted packet is obtained; and a combination thereof.

6. A communications audit support system which provides information necessary to audit encrypted communication performed between multiple communication devices, the system comprising:
a key management unit which, each time key information used for encrypted communication is created, stores the created key information in a key management database (DB) in association with a key ID with which the key information is identified;
a communication management unit which:
stores, when an encrypted communication session is established, characteristic information unique to each of multiple communication devices that perform the encrypted communication session, IP addresses of the multiple communication devices, and a time at which the encrypted communication session is started, in a communication state management DB in association with a key ID of key information used in the encrypted communication session; and
stores, after the encrypted communication session is ended, a time at which the encrypted communication session using the key information is ended, in the communication state management DB in association with the key ID of the key information;
a packet acquisition unit which obtains a copy of an encrypted packet sent in encrypted communication, and stores the obtained copy of the encrypted packet in a packet DB in association with IP addresses of a sender and a receiver of the encrypted packet, and with a time at which the copy of the encrypted packet is obtained; and
a communication information output unit which:
refers to the communication state management DB upon reception of a search instruction from a user;
identifies a key ID associated with characteristic information and IP address of a communication device that has performed an encrypted communication session identified by the search instruction, and with a start time and an end time of the encrypted communication session;
extracts, from the key management DB, key information that is associated with the identified key ID;
extracts, from the packet DB, a copy of an encrypted packet that is identified by the search instruction; and
outputs the extracted key information and copy of the encrypted packet.

7. A communications audit support system according to claim 6, wherein the search instruction contains one of: characteristic information of, or an IP address of, one of a sender and a receiver of an encrypted packet; a time slot in which a copy of the encrypted packet is obtained; and a combination thereof.

8. A communications audit support system according to claim 6, further comprising an audit condition storing unit which stores an audit condition set in advance in order to identify an audit subject encrypted communication session, wherein the packet acquisition unit
stores the obtained copy of the encrypted packet in the packet DB when the copy of the encrypted packet meets the audit condition, and
discards the encrypted packet when the obtained copy of the encrypted packet does not meet the audit condition.

9. A communications audit support system according to claim 8, further comprising a key information notification unit which, when the audit condition includes indicating immediate execution of auditing, and an encrypted communication session that meets the audit condition is established, obtains key information used in the encrypted communication session from the key management DB, and sends the obtained key information to the communication information output unit, wherein
when the audit condition includes indicating immediate execution of auditing, the packet acquisition unit further sends a copy of an encrypted packet that meets the audit condition, to the communication information output unit; and
the communication information output unit outputs the key information sent from the key information notification unit and the copy of the encrypted packet received from the packet acquisition unit.

10. A communications audit support system according to claim 8, wherein the audit condition contains one of: characteristic information of, or an IP address of, one of a sender and a receiver of an encrypted packet; a time slot in which a copy of the encrypted packet is obtained; and a combination thereof.
